(19) United States
(12) Patent Application Publication
(10) Pub. No.: US 2023/0394797 A1
(43) Pub. Date: Dec. 7, 2023

(54) DATA CREATION SYSTEM, LEARNING SYSTEM, ESTIMATION SYSTEM, PROCESSING DEVICE, EVALUATION SYSTEM, DATA CREATION METHOD, AND PROGRAM

(71) Applicant: Panasonic Intellectual Property Management Co., Ltd., Osaka (JP)

(72) Inventors: Ryosuke GOTO, Osaka (JP); Taichi SATO, Kyoto (JP); Yuto KITAGAWA, Osaka (JP)

(21) Appl. No.: 18/249,909

(22) PCT Filed: Nov. 5, 2021
(86) PCT No.: PCT/JP2021/040714

§ 371 Date: Apr. 20, 2023

(30) Foreign Application Priority Data
Nov. 10, 2020 (JP) 2020-187509

(51) Int. Cl. G06V 10/772; G06N 20/00

(52) U.S. Cl. CPC G06V 10/772; G06N 20/00

(57) ABSTRACT

A data creation system creates, based on first image data, second image data for use as learning data to generate a learned model. The data creation system includes an acquirer and a superimposer. The acquirer acquires feature image data indicating respective pixel values of a plurality of pixels included in a feature region. The superimposer creates the second image data by superimposing a magnitude of shift on respective pixel values of a plurality of pixels included in a predetermined region of a first image represented by the first image data. The predetermined region has an outer peripheral shape corresponding to the feature region. The magnitude of shift is determined based on the respective pixel values of the plurality of pixels included in the feature region.

### TECHNICAL FIELD

The present disclosure generally relates to a data creation system, a learning system, an estimation system, a processing device, an evaluation system, a data creation method, and a program. More particularly, the present disclosure relates to a data creation system, data creation method, and program for creating image data for use as learning data to generate a learned model. The present disclosure also relates to a processing device for use in the data creation system, an evaluation system including the processing device, a learning system for generating the learned model, and an estimation system that uses the learned model.

### BACKGROUND ART

Patent Literature 1 discloses an image generation system. The image generation system includes an acquirer, a calculator, a transformer, and an image generator. The acquirer acquires an image in a first region included in a first image and an image in a second region included in a second image. The calculator calculates a transformation parameter for transforming the image in the first region to make color information of the image in the first region similar to color information of the image in the second region. The transformer transforms the first image using the transformation parameter.

The image generator generates a third image by synthesizing the first image transformed and the second image. Specifically, supposing the width and height of the first image are (width, height) and particular coordinates of the second image are (x, y), the image generator superimposes the first image on the second image such that the particular coordinates (x, y) of the second image are located at the upper left corner of the first image and replaces pixel values of the second image with pixel values of the first image in a range from (x, y) to (x+width, y+height).

An X-ray image object recognition system as disclosed in Patent Literature 1 replaces, if the range from (x, y) to (x+width, y+height) of the second image is a predetermined region, pixel values of pixels in the predetermined region with pixel values of the first image. Thus, information about the pixel values of pixels in the predetermined region of the second image disappears from the third image, thus possibly generating an unreal image. Consequently, generating a learned model using the third image as learning data would cause a decline in learned model recognition performance in the inference phase.

### CITATION LIST

### Patent Literature

Patent Literature 1: JP 2017-45441 A

### SUMMARY OF INVENTION

In view of the foregoing background, it is therefore an object of the present disclosure to provide a data creation system, a learning system, an estimation system, a processing device, an evaluation system, a data creation method, and a program, all of which are configured or designed to reduce the chance of causing a decline in learned model recognition performance.

A data creation system according to an aspect of the present disclosure creates, based on first image data, second image data for use as learning data to generate a learned model. The data creation system includes an acquirer and a superimposer. The acquirer acquires feature image data indicating respective pixel values of a plurality of pixels included in a feature region. The superimposer creates the second image data by superimposing a magnitude of shift on respective pixel values of a plurality of pixels included in a predetermined region of a first image represented by the first image data. The predetermined region has an outer peripheral shape corresponding to the feature region. The magnitude of shift is determined based on the respective pixel values of the plurality of pixels included in the feature region.

A learning system according to another aspect of the present disclosure generates the learned model using a learning data set. The learning data set includes the learning data as the second image data created by the data creation system described above.

An estimation system according to still another aspect of the present disclosure makes estimation about an object to be recognized using the learned model generated by the learning system described above.

A processing device according to yet another aspect of the present disclosure functions as a first processing device of the data creation system including the first processing device and a second processing device. The first processing device includes an extractor that extracts, from third image data for use as the learning data, extract image data including respective pixel values of a plurality of pixels included in a predetermined extraction region. The second processing device includes the acquirer and the superimposer.

A processing device according to yet another aspect of the present disclosure functions as a second processing device of the data creation system including a first processing device and the second processing device. The first processing device includes an extractor that extracts, from third image data for use as the learning data, extract image data including respective pixel values of a plurality of pixels included in a predetermined extraction region. The second processing device includes the acquirer and the superimposer.

An evaluation system according to yet another aspect of the present disclosure includes a processing device and a learning system. The processing device extracts, from third image data representing a third image including a pixel region indicating an object to be recognized, extract image data including respective pixel values of a plurality of pixels included in a predetermined extraction region. The processing device outputs the extract image data thus extracted. The learning system generates a learned model. The learned model outputs, in response to either a second image represented by second image data or a predetermined region in the second image, an estimation result similar to a situation where the third image data is the object to be recognized. The predetermined region is a region included in the first image and having an outer peripheral shape corresponding to the extraction region. The first image includes a pixel region indicating the object to be recognized and is represented by first image data. The second image is created by superimposing a magnitude of shift on respective pixel values of a plurality of pixels included in the predetermined region of the first image. The magnitude of shift is determined based on the respective pixel values of the plurality of pixels included in the extraction region.

Another processing device according to yet another aspect of the present disclosure functions as the processing device of the evaluation system described above.

Another learning system according to yet another aspect of the present disclosure functions as the learning system of the evaluation system described above.

An evaluation system according to yet another aspect of the present disclosure includes a processing device and an estimation system. The processing device extracts, from third image data representing a third image including a pixel region indicating an object to be recognized, extract image data including respective pixel values of a plurality of pixels included in a predetermined extraction region. The processing device outputs the extract image data thus extracted. The estimation system makes estimation about the object to be recognized using a learned model. The learned model outputs, in response to either a second image represented by second image data or a predetermined region in the second image, an estimation result similar to a situation where the third image data is the object to be recognized. The predetermined region is a range included in the first image and having an outer peripheral shape corresponding to the extraction region. The first image includes a pixel region indicating the object to be recognized and is represented by first image data. The second image is created by superimposing a magnitude of shift on respective pixel values of a plurality of pixels included in the predetermined region of the first image. The magnitude of shift is determined based on the respective pixel values of the plurality of pixels included in the extraction region.

Another processing device according to yet another aspect of the present disclosure functions as the processing device of the evaluation system described above.

Another estimation system according to yet another aspect of the present disclosure functions as the estimation system of the evaluation system described above.

A data creation method according to yet another aspect of the present disclosure is a data creation method for creating, based on first image data, second image data for use as learning data to generate a learned model. The data creation method includes an acquiring step and a superimposing step. The acquiring step includes acquiring feature image data indicating respective pixel values of a plurality of pixels included in a feature region. The superimposing step includes creating the second image data by superimposing a magnitude of shift on respective pixel values of a plurality of pixels included in a predetermined region of a first image represented by the first image data. The predetermined region has an outer peripheral shape corresponding to the feature region. The magnitude of shift is determined based on the respective pixel values of the plurality of pixels included in the feature region.

A program according to yet another aspect of the present disclosure is designed to cause one or more processors to perform the data creation method described above.

### BRIEF DESCRIPTION OF DRAWINGS

FIG. 1 is a block diagram illustrating a schematic configuration for an overall evaluation system including a data creation system according to a first embodiment;

FIG. 2 illustrates an exemplary first image represented by first image data input to the data creation system;

FIG. 3 illustrates an exemplary defective product as an object to be recognized for a learned model in the data creation system;

FIG. 4 illustrates another exemplary defective product as another object to be recognized for the learned model in the data creation system;

FIG. 5 illustrates still another exemplary defective product as still another object to be recognized for the learned model in the data creation system;

FIG. 6 shows an exemplary third image represented by third image data to be input to the data creation system;

FIG. 7 illustrates an exemplary image represented by feature image data acquired by the data creation system;

FIG. 8 shows an exemplary first image represented by first image data input to the data creation system;

FIG. 9 shows an exemplary second image represented by second image data created by the data creation system;

FIG. 10 shows an exemplary image represented by feature image data acquired by the data creation system;

FIG. 11 illustrates a cross section of an object represented by feature image data acquired by the data creation system;

FIG. 12 illustrates how the data creation system may determine the magnitude of shift;

FIG. 13 illustrates how the data creation system may determine the magnitude of shift;

FIGS. 14A-14C illustrate how the data creation system may superimpose the magnitude of shift;

FIG. 15 illustrates how the data creation system may superimpose the magnitude of shift;

FIG. 16 illustrates how the data creation system may superimpose the magnitude of shift;

FIG. 17 is a flowchart showing the procedure of operation of the data creation system;

FIG. 18 illustrates how a data creation system according to a comparative example superimposes the magnitude of shift;

FIG. 19 is a block diagram illustrating a schematic configuration for an overall evaluation system including a data creation system according to a second embodiment;

FIG. 20 illustrates how the data creation system may define a maintaining region;

FIG. 21 illustrates how the data creation system may superimpose the magnitude of shift;

FIGS. 22A and 22B illustrate how the data creation system may determine the magnitude of shift;

FIG. 23 illustrates how the data creation system may superimpose the magnitude of shift;

FIG. 24 is a block diagram illustrating a schematic configuration for an overall evaluation system including a data creation system according to a first variation;

FIG. 25 illustrates how the data creation system may define a maintaining region;

FIG. 26 shows an exemplary image represented by feature image data acquired by a data creation system according to a second variation; and

FIG. 27 is a block diagram illustrating a schematic configuration for a data creation system according to a third variation.

### DESCRIPTION OF EMBODIMENTS

The drawings to be referred to in the following description of embodiments are all schematic representations. Thus, the ratio of the dimensions (including thicknesses) of respective constituent elements illustrated on the drawings does not always reflect their actual dimensional ratio.

### (1) First Embodiment

(1.1) Overview

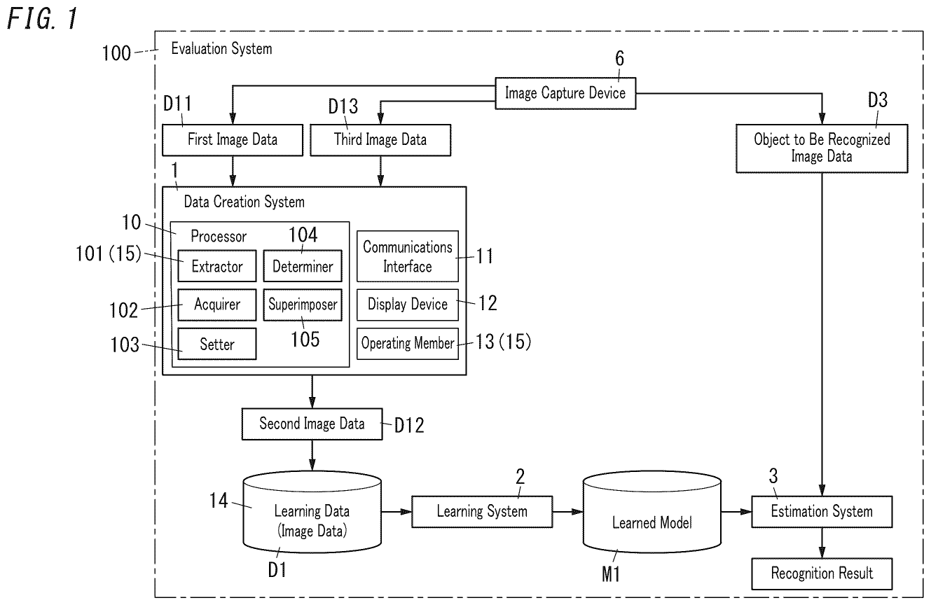

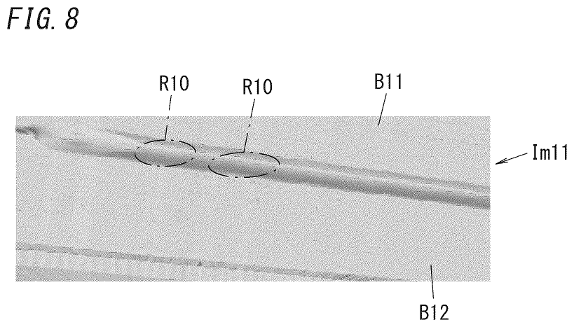

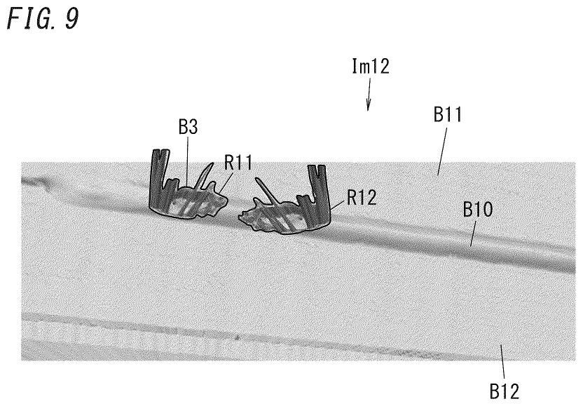

A data creation system 1 according to an exemplary embodiment creates second image data D12 based on first image data D11 as shown in FIG. 1. The first image data D11 is data showing information about an image (first image Im11, refer to FIG. 8). The second image data D12 is data showing information about another image (second image Im12, refer to FIG. 9). Information about each image includes coordinates (X coordinates and Y coordinates) of a plurality of pixels that form the image and pixel values corresponding to the respective coordinates.

The second image data D12 is used as learning data to generate a learned model M1. In other words, the second image data D12 is learning data for use to generate a model by machine learning. As used herein, the “model” refers to a program designed to estimate, in response to input of data about an object to be recognized (object), the condition of the object to be recognized and output a result of estimation (recognition result). Also, as used herein, the “learned model” refers to a model about which machine learning using learning data is completed. Furthermore, the “learning data” refers to a data set including, in combination, input information (image data D1) to be entered for a model and a label attached to the input information, i.e., so-called “training data.” That is to say, in this embodiment, the learned model M1 is a model about which machine learning has been done by supervised learning.

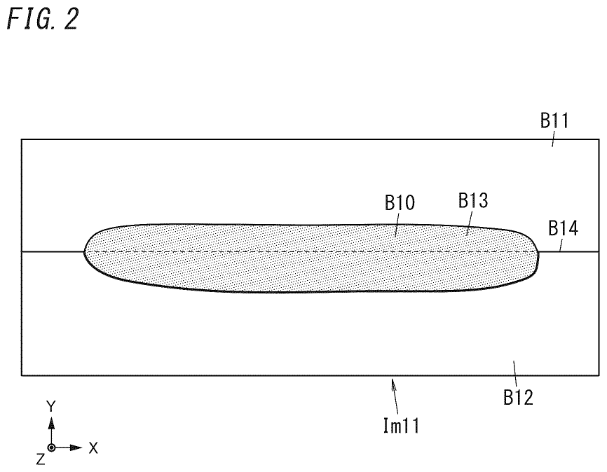

In this embodiment, the object as an object to be recognized may be, for example, a bead B10 as shown in FIG. 2. The bead B10 is formed, when two or more welding base materials (e.g., a first base metal B11 and a second base metal B12 in this example) are welded together via a welding material B13, in the boundary B14 (welding spot) between the first base metal B11 and the second base metal B12. In FIG. 2, the first base metal B11 and the second base metal B12 are arranged along a Y-axis (vertically) and the bead B10 is formed to be elongate along an X-axis (laterally). The dimensions and shape of the bead B10 depend mainly on the welding material B13. Thus, when object to be recognized image data D3 covering the bead B10 is entered, the learned model M1 estimates the condition of the bead B10 and outputs a result of estimation. Specifically, the learned model M1 outputs, as the result of estimation, information indicating whether the bead B10 is a defective product or a non-defective (i.e., good) product and information about the type of the defect if the bead B10 is a defective product. That is to say, the learned model M1 is used to determine whether the bead B10 is a good product or not. In other words, the learned model M1 is used to conduct a weld appearance test to determine whether welding has been done properly.

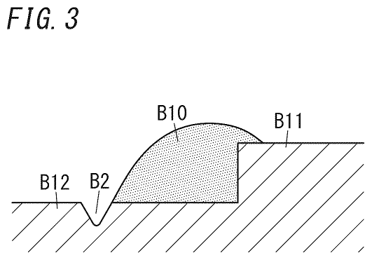

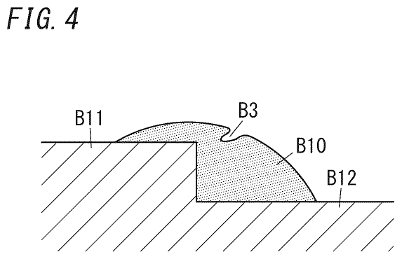

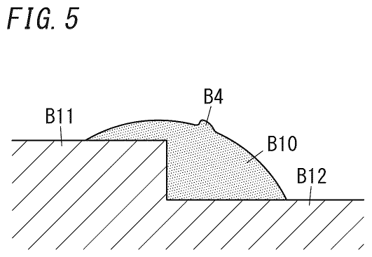

Decision about whether the bead B10 is good or defective may be made depending on, for example, whether the length of the bead B10, the height of the bead B10, the angle of elevation of the bead B10, the throat depth of the bead B10, the excess metal of the bead B10, and the misalignment of the welding spot of the bead B10 (including the degree of shift of the beginning of the bead B10) fall within their respective tolerance ranges. For example, if at least one of these parameters enumerated above fails to fall within its tolerance range, then the bead B10 is determined to be a defective product. Alternatively, decision about whether the bead B10 is good or defective may also be made depending on, for example, whether the bead B10 has any undercut B2 (refer to FIG. 3), whether the bead B10 has any pit B3 (refer to FIG. 4), whether the bead B10 has any sputter B4 (refer to FIG. 5), and whether the bead B10 has any projection. For example, if at least one of these imperfections enumerated above is spotted, then the bead B10 is determined to be a defective product. In the following description, such an imperfection will be hereinafter sometimes referred to as a “defect.”

To make machine learning about a model, a great many image data items about the objects to be recognized, including defective products, need to be collected as learning data. However, if the objects to be recognized turn out to be defective at a low frequency of occurrence, then learning data required to generate a learned model M1 with high recognizability tends to be short. Thus, to overcome this problem, machine learning about a model may be made with the number of learning data items increased by performing data augmentation processing about learning data (original learning data) acquired by actually shooting the bead B10 using an image capture device. As used herein, the data augmentation processing refers to the processing of expanding learning data by subjecting the learning data to various types of processing such as translation, scaling up or down (expansion or contraction), rotation, flipping, and noise or defect application.

The data creation system 1 according to this embodiment creates the second image data D12 by, for example, superimposing (applying) magnitude of shift data, indicating a defect, on the first image data D11 as original learning data. In this manner, the learning data (i.e., image data of objects to be recognized including defective products) is expanded.

As shown in FIG. 1, the data creation system 1 includes an acquirer 102 and a superimposer 105.

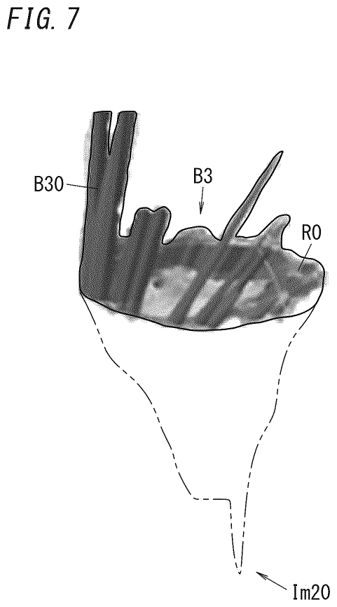

The acquirer 102 acquires feature image data indicating respective pixel values of a plurality of pixels included in a feature region R0 (refer to FIG. 7). The feature image data includes the coordinates (X coordinates and Y coordinates) of respective pixels included in an image Im20 representing the predetermined feature region R0 and the pixel values (data values) of the respective pixels. The feature region R0 may be, for example, a region with the defect. The feature image data may be extracted from, for example, original learning data (third image data D13), representing an image (including a defect) of the object to be recognized, as data indicating a region with a defect as will be described later.

The superimposer 105 creates the second image data D12 by superimposing the magnitude of shift on respective pixel values of a plurality of pixels included in a predetermined region R10 (refer to FIG. 8) of the first image Im11 represented by the first image data D11. The predetermined region R10 is a region having an outer peripheral shape corresponding to the feature region R0. The magnitude of shift is determined based on the respective pixel values of the plurality of pixels included in the feature region R0. The magnitude of shift may be determined, for example, with respect to every one of the pixels that form the feature region R0. The magnitude of shift may be determined by, for example, a determiner 104. It will be described later how the determiner 104 determines the magnitude of shift. Also, as used herein, to “superimpose” means adding the magnitude of shift to the pixel values of the pixels included in the first image Im11.

As can be seen, according to this embodiment, a second image Im12 is generated by superimposing the magnitude of shift on the respective pixel values of a plurality of pixels included in a predetermined region R10 of the first image Im11. Thus, this embodiment allows the pixel values of the pixels of the first image Im11 (i.e., an image represented by the first image data D11 that is original learning data) to be reflected on the pixel values of respective pixels in a region included in the second image Im12 and corresponding to the predetermined region R10. This enables generating learning data representing an image closer to an image that can exist in the real world, thus contributing to reducing the chances of causing a decline in the performance of recognizing the learned model M1 generated based on the learning data.

Also, a learning system 2 (refer to FIG. 1) according to this embodiment generates a learned model M1 using a learning data set including learning data as the second image data D12 created by the data creation system 1. This contributes to reducing the chances of causing a decline in the performance of recognizing the learned model M1. The learning data for use to generate the learned model M1 may include not only the second image data D12 (expanded data) but also the original first image data D11 as well. In other words, the image data D1 according to this embodiment includes at least the second image data D12 and may include both the first image data D11 and the second image data D12. Furthermore, the learning data for use to generate the learned model M1 may include original learning data (third image data D13) representing an image (including a defect) of the object to be recognized.

An estimation system 3 (refer to FIG. 1) according to this embodiment makes estimation about an object (e.g., the bead B10) as the object to be recognized using the learned model M1 generated by the learning system 2. This contributes to reducing the chances of causing a decline in the performance of recognizing the learned model M1.

A data creation method according to this embodiment is designed to create, based on first image data D11, second image data D12 for use as learning data to generate a learned model M1. The data creation method includes an acquiring step and a superimposing step. The acquiring step includes acquiring feature image data indicating respective pixel values of a plurality of pixels included in a feature region R0. The superimposing step includes creating the second image data D12 by superimposing a magnitude of shift on respective pixel values of a plurality of pixels included in a predetermined region R10 of a first image Im11 represented by the first image data D11. The predetermined region R10 has an outer peripheral shape corresponding to the feature region R0. The magnitude of shift is determined based on the respective pixel values of the plurality of pixels included in the feature region R0. This contributes to reducing the chances of causing a decline in the performance of recognizing the learned model M1. The data creation method is used on a computer system (data creation system 1). That is to say, the data creation method may also be implemented as a program. A program according to this embodiment is designed to cause one or more processors to perform the data creation method according to this embodiment. The program may be distributed after having been recorded in some non-transitory storage medium.

(1.2) Details

Next, an overall system including the data creation system 1 according to this embodiment (hereinafter referred to as an “evaluation system 100”) will now be described in detail with reference to the accompanying drawings.

(1.2.1) Overall Configuration

As shown in FIG. 1, the evaluation system 100 includes the data creation system 1, the learning system 2, the estimation system 3, and one or more image capture devices 6 (only one of which is shown in FIG. 1).

The data creation system 1, the learning system 2, and the estimation system 3 are supposed to be implemented as, for example, a server. The server as used herein is supposed to be implemented as a single server device. That is to say, major functions of the data creation system 1, the learning system 2, and the estimation system 3 are supposed to be provided for a single server device.

Alternatively, the server may also be implemented as a plurality of server devices. Specifically, the functions of the data creation system 1, the learning system 2, and the estimation system 3 may be provided for three different server devices. Alternatively, two out of these three systems may be provided for a single server device. Optionally, those server devices may form a cloud computing system, for example.

Furthermore, the server device may be installed either inside a factory as a place where welding is performed or outside the factory (e.g., at a service headquarters), whichever is appropriate. If the respective functions of the data creation system 1, the learning system 2, and the estimation system 3 are provided for three different server devices, then each of these server devices is preferably connected to the other server devices to be ready to communicate with the other server devices.

The data creation system 1 is configured to create image data D1 for use as learning data to generate the learned model M1. As used herein, to “create learning data” may refer to not only generating new learning data separately from the original learning data but also generating new learning data by updating the original learning data.

The learned model M1 as used herein may include, for example, either a model that uses a neural network or a model generated by deep learning using a multilayer neural network. Examples of the neural networks may include a convolutional neural network (CNN) and a Bayesian neural network (BNN). The learned model M1 may be implemented by, for example, installing a learned neural network into an integrated circuit such as an application specific integrated circuit (ASIC) or a field-programmable gate array (FPGA). However, the learned model M1 does not have to be a model generated by deep learning. Alternatively, the learned model M1 may also be a model generated by a support vector machine or a decision tree, for example.

In this embodiment, the data creation system 1 has the function of expanding the learning data by performing data augmentation processing on the original learning data (first image data D11) as described above. In the following description, a person who uses the evaluation system 100 including the data creation system 1 will be hereinafter simply referred to as a “user.” The user may be, for example, an operator who monitors a manufacturing process such as a welding process step in a factory or a chief administrator.

As shown in FIG. 1 the data creation system 1 includes a processor 10, a communications interface 11, a display device 12, and an operating member 13.

In the example illustrated in FIG. 1, a storage device 14 for storing the learning data (image data D1) is provided outside of the data creation system 1. However, this is only an example and should not be construed as limiting. Alternatively, the data creation system 1 may further include the storage device 14. In that case, the storage device 14 may also be a memory built in the processor 10. The storage device 14 for storing the image data D1 includes a programmable nonvolatile memory such as an electrically erasable programmable read-only memory (EEPROM).

Optionally, some functions of the data creation system 1 may be distributed in a telecommunications device with the capability of communicating with the server. Examples of the telecommunications devices as used herein may include personal computers (including laptop computers and desktop computers) and mobile terminal devices such as smartphones and tablet computers. In this embodiment, the functions of the display device 12 and the operating member 13 are provided for the telecommunications device to be used by the user. A dedicated application software program allowing the telecommunications device to communicate with the server is installed in advance in the telecommunications device.

The processor 10 may be implemented as a computer system including one or more processors (microprocessors) and one or more memories. That is to say, the one or more processors may perform the functions of the processor 10 by executing one or more programs (applications) stored in the one or more memories. In this embodiment, the program is stored in advance in the memory of the processor 10. Alternatively, the program may also be downloaded via a telecommunications line such as the Internet or distributed after having been stored in a non-transitory storage medium such as a memory card.

The processor 10 performs the processing of controlling the communications interface 11, the display device 12, and the operating member 13. The functions of the processor 10 are supposed to be performed by the server. In addition, the processor 10 also has the function of performing image processing. In particular, the processor 10 has the function of performing data augmentation processing of creating the second image data D12 based on the first image data D11. The processor 10 will be described in detail later in the next section.

The display device 12 may be implemented as either a liquid crystal display or an organic electroluminescent (EL) display. The display device 12 is provided for the telecommunications device as described above. Optionally, the display device 12 may also be a touchscreen panel display. The display device 12 displays (outputs) information about the first image data D11, the second image data D12, and the third image data D13. In addition, the display device 12 also displays various types of information about the generation of learning data besides the first image data D11, the second image data D12, and the third image data D13.

Examples of the operating member 13 include a mouse, a keyboard, and a pointing device. The operating member 13 may be provided, for example, for the telecommunications device to be used by the user as described above. If the display device 12 is a touchscreen panel display of the telecommunications device, then the display device 12 may also have the function of the operating member 13.

The communications interface 11 is a communications interface for communicating with one or more image capture devices 6 either directly or indirectly via, for example, another server having the function of a production management system. In this embodiment, the function of the communications interface 11, as well as the function of the processor 10, is supposed to be provided for the same server. However, this is only an example and should not be construed as limiting. Alternatively, the function of the communications interface 11 may also be provided for the telecommunications device, for example. The communications interface 11 receives, from the image capture device 6, the first image data D11 as the original learning data. In addition, the communications interface 11 also receives, from the image capture device 6, the third image data D13 as original learning data representing an image (including a defect) of the object to be recognized.

In this embodiment, the image capture device 6 is a distance image sensor for measuring the distance to the object. The image capture device 6 measures the distance to the object by, for example, the time of flight (TOF) method. Thus, the image data captured by the image capture device 6 is distance image data in which each of the plurality of pixels of the image is provided with a value indicating the distance from the image capture device 6 to the object. In short, each of the first image data D11 and the third image data D13 is distance image data in which the pixel value of each pixel is a distance value.

The first image data D11 is data representing the first image Im11 covering the object to be recognized as shown in FIG. 2. As described above, the object to be recognized may be, for example, the bead B10 formed, when the first base metal B11 and the second base metal B12 are welded together via the welding material B13, in the boundary B14 between the first base metal B11 and the second base metal B12.

The first image data D11 is chosen as the target of the data augmentation processing in accordance with, for example, the user's command from a great many image data items about the object to be recognized shot with the image capture device 6. The evaluation system 100 preferably includes a user interface (which may be the operating member 13) that accepts the user's command about his or her choice.

The learning system 2 generates the learned model M1 using a learning data set including a plurality of image data items D1 (including a plurality of second image data items D12) created by the data creation system 1. The learning data set is generated by attaching a label indicating either a good product or a defective product or a label indicating the type and location of the defect as for the defective product to each of a plurality of image data items D1. Examples of the types of defects include undercut, pit, and sputter. The work of attaching the label is performed on the evaluation system 100 by the user via a user interface such as the operating member 13. In one variation, the work of attaching the label may also be performed by a learned model having the function of attaching a label to the image data D1. The learning system 2 generates the learned model M1 by making, using the learning data set, machine learning about the conditions (including a good condition, a bad condition, the type of the defect, and the location of the defect) of the object to be recognized (e.g., the bead B10).

Optionally, the learning system 2 may attempt to improve the performance of the learned model M1 by making re-learning using a learning data set including newly acquired learning data. For example, if a new type of defect is found in the object to be recognized (e.g., the bead B10), then the learning system 2 may be made to do re-learning about the new type of defect.

The estimation system 3 estimates, using the learned model M1 generated by the learning system 2, the conditions (including a good condition, a bad condition, the type of the defect, and the location of the defect) of the object to be recognized. The estimation system 3 is configured to be ready to communicate with one or more image capture devices 6 either directly or indirectly via, for example, another server having the function of a production management system. The estimation system 3 receives object to be recognized image data D3 generated by shooting the bead B10, which has been formed by actually going through a welding process step, with the image capture device 6.

The estimation system 3 determines, based on the learned model M1, whether the bead B10 shot in the object to be recognized image data D3 is a good product or a defective product and estimates, if the bead B10 is a defective product, the type and location of the defect. The estimation system 3 outputs the result of recognition (i.e., the result of estimation) about the object to be recognized image data D3 to, for example, the telecommunications device used by the user or the production management system. This allows the user to check the result of estimation through the telecommunications device. Optionally, the production management system may control the production facility to discard a welded part that has been determined, based on the result of estimation acquired by the production management system, to be a defective product before the part is transported and subjected to the next process step.

(1.2.2) Data Augmentation Processing

The processor 10 has the function of performing the data augmentation processing. Specifically, as shown in FIG. 1, the processor 10 includes an extractor 101, the acquirer 102, a setter 103, a determiner 104, and the superimposer 105. Note that the extractor 101, the acquirer 102, the setter 103, the determiner 104, and the superimposer 105 do not have a substantive configuration but just represent functions to be performed by the processor 10.

The extractor 101 extracts, from the third image data D13 for use as the learning data, extract image data including respective pixel values of a plurality of pixels included in a predetermined extraction region R1.

As described above, in this embodiment, the third image data D13 is data representing an image (including a defect (refer to FIGS. 3-5)) of the object to be recognized. The extractor 101 extracts, as the extraction region R1, a region with a defect, for example.

The extraction region R1 may be defined by, for example, the user using the telecommunications device.

The extractor 101 makes the display device 12 display a three-dimensional image (third image) Im13 represented by the third image data D13. As described above, the third image data D13 is distance image data. Thus, the processor (extractor 101) determines the three-dimensional shape of the object by setting, with respect to each pixel, a constituent point of which the coordinates and pixel value of the pixel are used as coordinate values (i.e., X, Y, and Z coordinates) of a three-dimensional coordinate system, and connecting a plurality of such constituent points together. Then, the processor 10 projects the three-dimensional shape of the object thus determined onto a two-dimensional plane, thereby having a three-dimensional image Im13 (projected image) displayed on the display device 12. The projected image displayed on the display device 12 preferably has a viewpoint position or any other parameter thereof changeable in accordance with the user's operating command entered via the operating member 13.

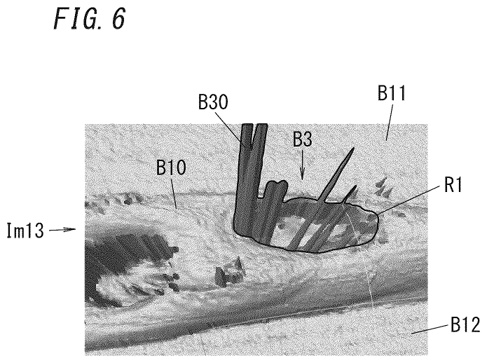

FIG. 6 shows an exemplary three-dimensional image Im13 (projected image). In the example shown in FIG. 6, a pit B3 has been formed as a defect in a part of the bead B10. Note that in the example shown in FIG. 6, a plurality of projections B30, each of which protrudes away from the pit B3, are displayed on an outer peripheral portion of the pit B3. These projections B30 are caused by noise and are actually nonexistent in the real bead B10.

The user specifies the extraction region R1 using the operating member 13, while looking at the three-dimensional image Im13 displayed on the display device 12. In the example shown in FIG. 6, the user may specify the extraction region R1 by selecting, using a pointer, for example, a plurality of pixels included in the pit B3 region. Alternatively, the extraction region R1 may also be specified by making the user select a plurality of pixels that form the outer periphery of the pit B3. Still alternatively, the extraction region R1 may also be specified by making the user specify a region having an arbitrary shape (e.g., a rectangular shape) such that the region includes the pit B3 inside.

In a specify example, the extractor 101 has the three-dimensional image Im13 and an end button displayed on the display device 12. The user specifies, using a mouse as the operating member 13, several points (as contour points) along the contour of the extraction region R1 (e.g., along the circumference thereof) and then presses the end button displayed on the display device 12. The extractor 101 defines the extraction region R1 to be a range formed by connecting the specified contour points to each other via lines, curves, or a combination thereof. As can be seen, the data creation system 1 may further include a specifier 15 (of work the function is performed by the operating member 13 and the extractor 101 in combination) for specifying the predetermined extraction region R1 based on the third image data D13 and in accordance with the user's operating command.

The extractor 101 extracts, as the extract image data, data about the extraction region R1 specified by the user from the third image data D13.

The acquirer 102 acquires feature image data indicating the pixel values of a plurality of pixels included in the feature region R0. In this example, the acquirer 102 acquires, as the feature image data, the extract image data extracted by the extractor 101. Thus, the shape (outer peripheral shape) of the feature region R0 corresponds to (i.e., agrees with) the shape of the extraction region R. Also, the feature image data includes, as pixel values of a plurality of pixels in the feature region R0, the pixel values of a plurality of pixels included in the extraction region R1.

FIG. 7 illustrates an exemplary three-dimensional image Im20 (projected image) represented by the feature image data. In the exemplary three-dimensional image Im20 shown in FIG. 7, the extract image data about the extraction region R1 extracted from the third image Im13 shown in FIG. 6 has been acquired as the feature image data. Since the pit B3 is included in the extraction region R1, which is the source of the extract image data, the three-dimensional shape object represented by the feature image data has a bottom recessed from the outer peripheral portion of the feature region R0 (i.e., the bottom surface of the pit B3). In FIG. 7, the bottom surface of the pit B3 is schematically indicated by the two-dot chain.

The determiner 104 determines the magnitude of shift based on the respective pixel values of the plurality of pixels in the feature region R0. In this embodiment, the determiner 104 transforms the respective pixel values of the plurality of pixels in the feature region R0 into the magnitude of shift. In this embodiment, the determiner 104 functions as a transformer for transforming the respective pixel values of the plurality of pixels in the feature region R0 into the magnitude of shift.

The determiner 104 determines the magnitude of shift based on either a virtual section or a virtual line. Specifically, the determiner 104 transforms, based on either a virtual section or a virtual line, the respective pixel values of the plurality of pixels in the feature region R0 into the magnitude of shift. The virtual section or the virtual line is set by the setter 103 using the pixel values of two or more pixels that form the outer periphery (contour) of the feature region R0.

More specifically, the setter 103 sets, with respect to each of the two or more pixels that form the outer periphery of the feature region R0, a constituent point P1 of which the coordinates and pixel value of a pixel are defined as the coordinate values (X coordinate, Y coordinate, Z coordinate) of a three-dimensional coordinate system. The setter 103 sets, using the coordinate values of a plurality of such constituent points P1, either a virtual section or a virtual line within the three-dimensional coordinate system.

In this embodiment, the setter 103 sets, as the virtual section or virtual line, a plurality of virtual lines. Each of the plurality of virtual lines is set as a line segment A1 that connects together two constituent points P1 arranged side by side in one direction among respective constituent points P1 of two or more pixels that form the outer periphery of the feature region R0.

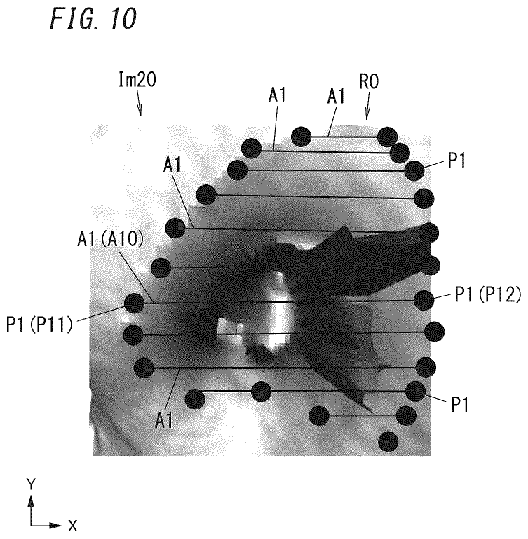

For example, as shown in FIG. 10, the setter 103 selects an arbitrary one of a plurality of pixels that form the outer periphery of the feature region R0, thereby selecting one constituent point P1 corresponding to the pixel. When one constituent point P1 (e.g., the constituent point P11 shown in FIG. 10) is selected, the setter 103 sets a line segment A1 (e.g., the line segment A10 shown in FIG. 10), of which the beginning is the constituent point P11 and of which the end point is a constituent point P1 (such as the constituent point P12 shown in FIG. 10) adjacent to the constituent point P11 in one direction (e.g., the X-axis direction in FIG. 10) and forming part of the outer periphery of the feature region R0. In this manner, one line segment A1 is set as a virtual line. The setter 103 sets the line segments A1 in the same way with respect to a plurality of pixels (i.e., a plurality of constituent points P1) that form the outer periphery of the feature region R0. In this manner, a plurality of line segments A1 are set as a plurality of virtual lines (refer to FIG. 10).

It can be said that the plurality of line segments A1 (virtual lines) thus set represent a virtual section defined by the outer periphery of the feature region R0 (e.g., an aperture of the pit B3 if the feature region R0 is the pit B3).

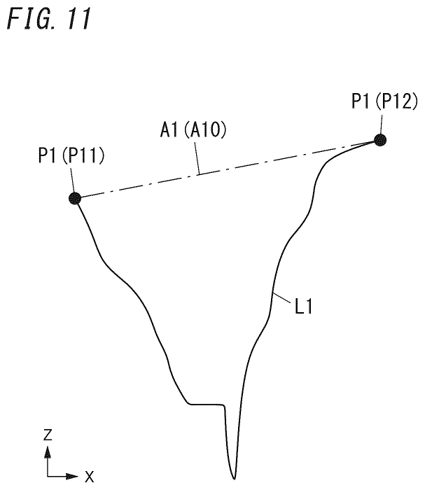

In this case, the outer periphery of the feature region R0 is not necessarily flat (i.e., the Z coordinate values are not always constant). Thus, a line segment A1 that connects two constituent points P1 to each other may be inclined with respect to the X-Y plane. FIG. 11 shows a line L1 passing through a surface of the object (i.e., an inner surface of the pit B3) and taken along a plane that passes through the line segment A10 shown in FIG. 10 and the Z-axis. As shown in FIG. 11, the constituent point P12 has a larger Z coordinate value than the constituent point P11, thus making the line segment A10 inclined with respect to the X-axis.

The determiner 104 transforms, based on a plurality of virtual lines (line segments A1) thus set, the respective pixel values (i.e., Z coordinate values) of a plurality of pixels included in the feature region R0 into the magnitude of shift. Specifically, the determiner 104 transforms the respective pixel values of a plurality of pixels corresponding to each of the plurality of line segments A1 into the magnitude of shift such that the magnitude of shift becomes equal to zero at the two constituent points P1 at both ends of a line segment A1 of interest.

The determiner 104 sets, with respect to each of a plurality of pixels included in the feature region R0, a constituent point of which the coordinates and pixel value of a pixel of interest are defined as coordinate values (X coordinate, Y coordinate, and Z coordinate) of a three-dimensional coordinate system. Then, the determiner 104 transforms, based on the distances between the respective coordinate values of the constituent points and the virtual section or virtual line (i.e., distances in the Z-axis direction) with respect to a plurality of pixels, the respective pixel values of a plurality of pixels included in the feature region R0 into the magnitude of shift.

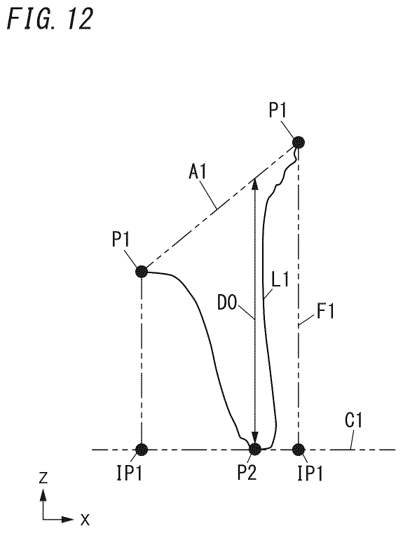

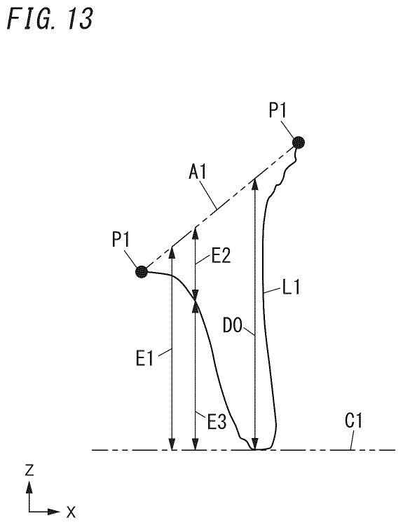

Next, it will be described with reference to FIGS. 12 and 13 how the determiner 104 may determine the magnitude of shift in one example.

As shown in FIG. 12, the determiner 104 locates a constituent point P2 that has a smaller pixel value (Z coordinate value) than any other one of the constituent points with respect to a plurality of pixels corresponding to the line segment A1 (i.e., the constituent points that form a line L1 representing a surface of the object) and sets a straight line C1 passing through the constituent point P2 and parallel to the X-axis. The determiner 104 determines a distance D0 in the Z-axis direction between the constituent point P2 and the line segment A1.

In addition, as shown in FIG. 13, the determiner 104 also determines a distance E1 in the Z-axis direction from the line segment A1 to the straight line C1, a distance E2 in the Z-axis direction from a constituent point to the line segment A1, and a distance E3 in the Z-axis direction from the constituent point to the straight line C1 with respect to each of constituent points for a plurality of pixels corresponding to the line segment A1. As is clear from this definition, E1=E2+E3 is satisfied with respect to each constituent point.

The determiner 104 calculates the ratio (E2/E1) of the distance E2 to the distance E1 and sets the ratio multiplied by the distance D0 (i.e., D0×E2/E1) as the magnitude of shift with respect to each constituent point. In this example, the distance E2 is equal to zero at the constituent points P1 (i.e., the constituent points P1 at both ends of the line segment A1) with respect to the pixels that form the outer periphery of the feature region R0. Thus, the magnitude of shift is equal to zero at these constituent points P1. Meanwhile, as for the constituent point P2, since distance E2=distance E1, the magnitude of shift is equal to DO.

The superimposer 105 creates the second image data D12 by superimposing the magnitude of shift on the respective pixel values of a plurality of pixels included in the predetermined region R10 of the first image Im11 represented by the first image data D11.

The first image data D11 is image data for use as the learning data and may be, for example, original learning data with no defects with respect to the object to be recognized (i.e., of which the object to be recognized is a good product). FIG. 8 shows an exemplary three-dimensional image Im11 (projected image) as the first image Im11 represented by the first image data D11.

The predetermined region R10 may be an arbitrary region included in the first image Im11 and having an outer peripheral shape corresponding to the feature region R0.

The predetermined region R10 may be specified by, for example, the user using the telecommunications device described above. The user may specify the predetermined region R10 using, for example, the operating member 13 while looking at the three-dimensional image Im11 displayed on the display device 12. In the example shown in FIG. 8, the user specifies the predetermined region R10 by selecting, using a pointer on the display device 12, for example, the coordinates of an arbitrary point included in the predetermined region R10 (e.g., if the predetermined region R10 has a circular shape on an X-Y plane, then the user selects the coordinates of the center of the circle). As described above, the outer peripheral shape of the predetermined region R10 is determined to correspond to the outer peripheral shape of the feature region R0. Thus, specifying the coordinates of one point included in the predetermined region R10 enables specifying the location of the entire predetermined region R10. Note that if an image represented by the feature image data is allowed to rotate, then not only the coordinates of an arbitrary point included in the predetermined region R10 but also the angle of rotation may be specified.

The superimposer 105 superimposes the magnitude of shift determined by the determiner 104 on the respective pixel values of a plurality of pixels included in the predetermined region R10 thus specified. That is to say, the superimposer 105 adds the magnitude of shift determined by the determiner 104 with respect to each pixel of each line segment A1 to the pixel value of a pixel corresponding to the former pixel in the predetermined region R10.

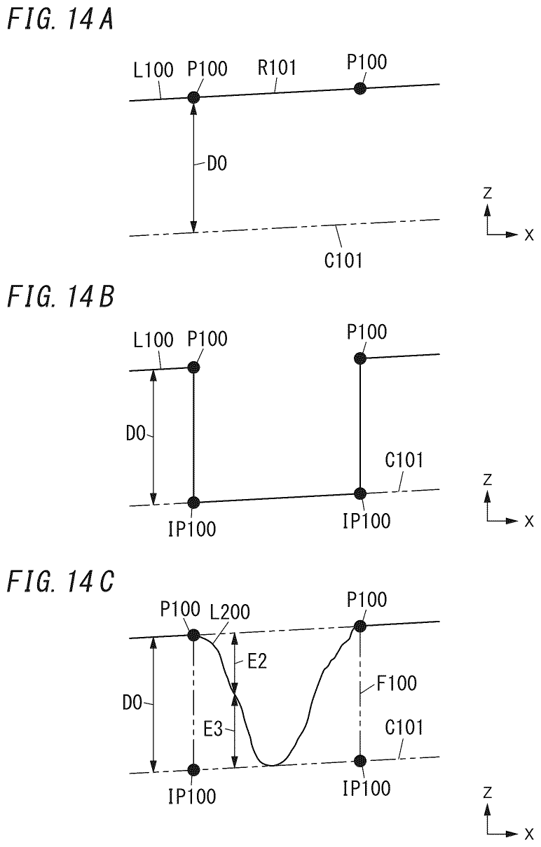

Next, specific exemplary superimposition processing by the superimposer 105 will be described with reference to FIGS. 14A-14C.

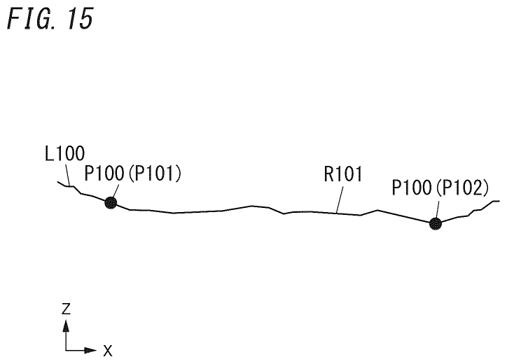

The superimposer 105 locates two pixels corresponding to two pixels for the constituent points P1 at both ends of the line segment A1 as the origin of superimposition among a plurality of pixels included in the predetermined region R10 of the first image Im11 and locates the constituent points P100 with respect to these two pixels located. In addition, the superimposer 105 also determines a line segment R101 (which forms part of a line L100 passing through the surface of the object) connecting these two constituent points P1 to each other and defined by a plurality of constituent points (refer to FIG. 14A). The line L100 and the line segment R101 are lines representing the contour (surface) shape of the object taken along an X-Z plane. Note that although the line L100 is illustrated as a straight line in FIG. 14A for convenience sake, the line L100 (line segment R101) actually has an uneven shape corresponding to the unevenness of the surface of the object as shown in FIG. 15.

In addition, the superimposer 105 also sets a virtual line C101 by shifting the line L100 by a distance D0 in the Z-axis direction. This virtual line C101, as well as the line L100 (line segment R101), actually has an uneven shape corresponding to the unevenness of the surface of the object.

Next, the superimposer 105 replaces, with respect to each of the plurality of constituent points that form the line segment R101 (i.e., part, located between the constituent points P100, P100, of the line L100), the pixel value (Z coordinate value) thereof with the value of the virtual line C101 (refer to FIG. 14B).

Finally, the superimposer 105 determines a line L200 passing through the surface of the object after the superimposition by shifting, with respect to each of the plurality of constituent points that form the line segment R101, the pixel value (Z coordinate value) back toward the line segment R101 by the ratio of the distance E3 to the distance E1 multiplied by the distance D0 (i.e., D0×E3/E1) (refer to FIG. 14C). In this manner, a new pixel value may be determined by adding the magnitude of shift (D0−D0×E3/E1)=D0×E2/E1 to the original pixel value with respect to each of a plurality of pixels corresponding to the plurality of constituent points that form the line L200.

Viewing it from a different perspective, the determiner 104 transforms the respective pixel values of a plurality of pixels corresponding to the line segment A1 into the magnitude of shift by transforming, by projective transformation, an image inside the quadrangular frame F1 shown in FIG. 12 into the image inside the quadrangular frame F100 shown in FIG. 14C. The quadrangular frame F1 is defined by the two constituent points P1 and two virtual points IP1 defined as the intersections between the two straight lines extended in the Z-axis direction from the two constituent points P1 and the straight line C1. The quadrangular frame F100 is defined by the two constituent points P100 and two virtual points IP100 defined as the intersections between the two straight lines extended in the Z-axis direction from the two constituent points P100 and the virtual line C101. Then, the superimposer 105 adds the magnitude of shift determined by the determiner 104 with respect to each pixel on the line segment A1 to the pixel value of a pixel corresponding to the former pixel on the line segment R101. In short, the determiner 104 determines the magnitude of shift by projective transformation.

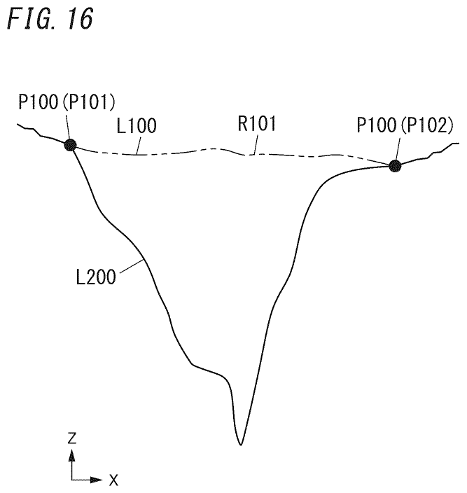

FIG. 16 shows the shape of a line L200 passing through the surface of the object after the superimposition and obtained by superimposing the magnitude of shift, determined by transforming the cross-sectional shape shown in FIG. 11 (i.e., the line L1 passing through the surface of the object), on the pixel values of pixels corresponding to the line segment R101 shown in FIG. 15. In FIG. 16, the line L100 (line segment R101) passing through the surface of the object before the magnitude of shift is superimposed is also shown in phantom.

The determiner 104 and the superimposer 105 perform such transformation and superimposition processing in the same way on the constituent point P100 corresponding to all the pixels that form the outer periphery of the predetermined region R10. As a result, second image data D12 in which the magnitude of shift is superimposed on (i.e., added to) the respective pixel values of a plurality of pixels included in the predetermined region R10 is created (refer to FIG. 9). In the example shown in FIG. 9, magnitude of shift data indicating the magnitude of shift is superimposed on each of two different regions R11, R12 (respectively corresponding to the two predetermined regions R10, R10 shown in FIG. 8) on the bead B10. The magnitude of shift data superimposed on the region R12 is obtained by subjecting the magnitude of shift data superimposed on the region R11 to flipping processing.

(1.2.3) Operation

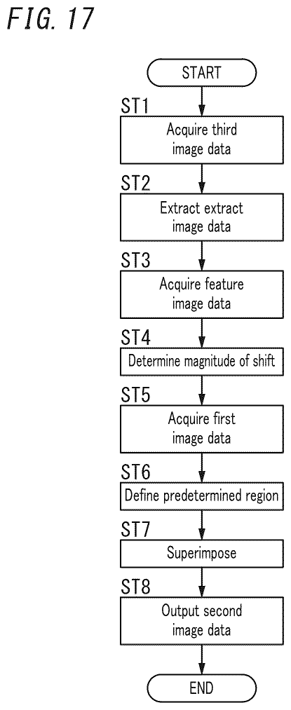

Next, an exemplary operation of the data creation system 1 will be described with reference to FIG. 17. Note that the procedure of operation to be described below is only an example and should not be construed as limiting.

First, to acquire feature image data, the processor 10 of the data creation system 1 acquires third image data D13 as original learning data representing an image with a defect about the object to be recognized (in ST1).

The processor 10 defines, in the third image data D13, an extraction region R1 with the defect. The processor 10 extracts extract image data including the respective pixel values of a plurality of pixels included in the extraction region R1 (in ST2) and acquires the extract image data as the feature image data (in ST3). Then, the processor 10 transforms the feature image data into magnitude of shift data, thereby determining the magnitude of shift (in ST4).

In addition, the processor 10 also acquires first image data D11 as original learning data (in ST5) and defines the predetermined region R10 in the first image Im11 represented by the first image data D11 (in ST6).

The processor 10 creates the second image data D12 by superimposing the magnitude of shift data on the predetermined region R10 (in ST7). Then, the processor 10 outputs the second image data D12 thus created (in ST8). The second image data D12 is stored as learning data (image data D1) in the storage device 14 with a label “defective” attached thereto as well as the third image data D13.

(1.2.4) Advantages

As described above, a data creation system 1 according to this embodiment creates second image data D12 by superimposing the magnitude of shift on respective pixel values of a plurality of pixels included in a predetermined region R10 of a first image Im11 represented by first image data D11. The magnitude of shift data has been generated such that the magnitude of shift becomes equal to zero at each of a plurality of pixels that form the outer periphery of the predetermined region R10.

In this case, the bead B10 has arbitrary height shape in the Z-axis direction. Thus, the height (i.e., a Z coordinate value) of an outer peripheral portion of the extraction region R1 of the third image data D13 as the source of superimposition does not always agree with the height (i.e., a Z coordinate value) of an outer peripheral portion of the predetermined region R10 of the first image data D11 as the destination of superimposition. Thus, simply replacing the respective pixel values of a plurality of pixels included in the predetermined region R10 with the respective pixel values of a plurality of pixels included in the extraction region R1 could cause a level difference in the Z-axis direction in a boundary portion of the predetermined region R10 in the image created after the replacement.

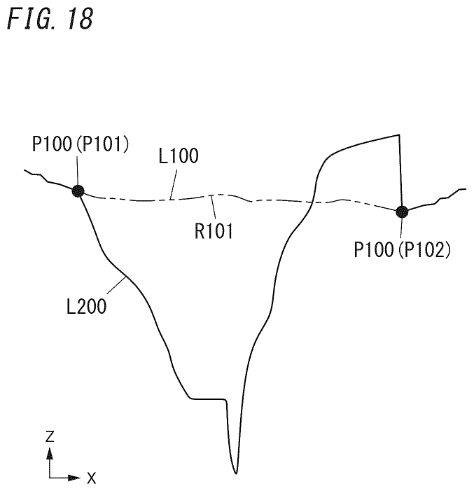

Meanwhile, it is imaginable that a data creation system as a comparative example creates magnitude of shift data to make the magnitude of shift equal to zero at one of a plurality of pixels that form the outer periphery of the predetermined region R10 (e.g., at a pixel corresponding to the constituent point P101 shown in FIG. 15) while maintaining correlation (i.e., difference) between the pixel values (Z coordinate values) of all pixels included in the feature region R0. This enables connecting, without causing any level difference, pixel portions corresponding to the constituent point P101 as shown in FIG. 18. In that case, however, a level difference may still be caused in the Z-axis direction at a pixel portion corresponding to a different constituent point P102, other than the constituent point P101, among a plurality of pixels that form the outer periphery of the predetermined region R10.

In contrast, the data creation system 1 according to this embodiment enables superimposing data without causing any level difference in the boundary portion, thus enabling creating pseudo data which is even closer to image data that can exist in the real world. Then, estimating the condition of the object to be recognized represented by the object to be recognized image data D3 based on a learned model M1 that has been generated using the second image data D12 thus obtained as learning data reduces the chances of recognizing the condition of the object to be recognized erroneously due to the presence of the level difference. Consequently, this enables contributing to reducing the chances of causing a decline in the performance of recognizing the learned model M1.

### (2) Second Embodiment

In a data creation system 1 according to a second embodiment, the processor 10 maintains, when transforming the feature image data into the magnitude of shift data, the correlation between the respective pixel values of adjacent pixels as for pixels falling within a predetermined range (hereinafter referred to as a “maintaining region”) of the feature region R0, which is a difference from the data creation system 1 according to the first embodiment described above. In the following description, any constituent element of this second embodiment, having substantially the same function as a counterpart of the data creation system 1 according to the first embodiment described above, will be designated by the same reference numeral as that counterpart's, and description thereof will be omitted herein as appropriate.

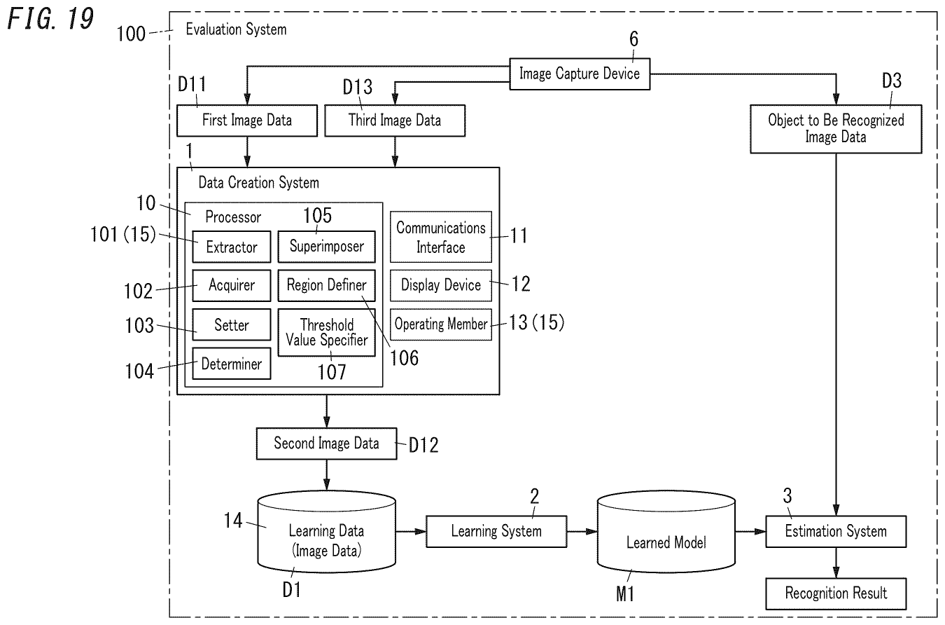

As shown in FIG. 19, the processor 10 according to this embodiment further includes a maintaining region definer 106 and a threshold value specifier 107. Note that the maintaining region definer 106 and the threshold value specifier 107 do not have a substantive configuration but just represent functions to be performed by the processor 10.

The threshold value specifier 107 sets a threshold value. In this embodiment, the threshold value specifier 107 sets the threshold value in accordance with the user's command. The threshold value is a value to be compared with the pixel values (Z coordinate values) of the plurality of pixels included in the extraction region R1 (feature region R0). The user sets the threshold value using the operating member 13 while looking at an image displayed on the display device 12.

For example, with a three-dimensional image Im13 (refer to FIG. 6) represented by the third image data D13 displayed on the display device 12, the threshold value specifier 107 has a pixel region where the pixel value (i.e., distance value) is equal to or greater than a threshold value and a pixel region where the pixel value (distance value) is less than the threshold value displayed in different modes (e.g., in two different colors). When the user changes the threshold value by operating the telecommunications device, what is displayed on the display device 12 (i.e., the ranges of the pixel region where the pixel value is equal to or greater than the threshold value and the pixel region where the pixel value is less than the threshold value) also changes in response. This allows the user to specify any desired threshold value while looking at the three-dimensional image Im13 displayed on the display device 12.

The maintaining region definer 106 defines the maintaining region based on the results of comparison between the threshold value and the respective pixel values of the plurality of pixels included in the feature region R0. For example, the maintaining region definer 106 sets a pixel region, of which the pixel value is less than the threshold value, as the maintaining region.

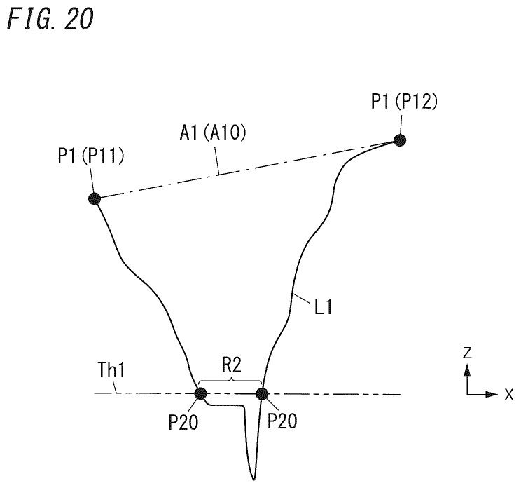

FIG. 20 shows an exemplary result of a maintaining region defined on a cross section passing through the line segment A10 shown in FIG. 10 and the Z-axis. In the example shown in FIG. 20, a region R2 between two intersections P20, P20 where a line L1 passing through the surface of the object and a line Th1 indicating the threshold value intersect with each other is defined as the maintaining region.

As can be seen, the maintaining region definer 106 defines the maintaining region based on the threshold value specified by the threshold value specifier 107.

The determiner 104 determines the magnitude of shift to maintain the correlation between the respective pixel values of the plurality of pixels included in the maintaining region. In other words, as for the rest of the feature region R0 (hereinafter referred to as a “transformation region”) other than the maintaining region, the determiner 104 allows the correlation between the respective pixel values (Z coordinate values) of the plurality of pixels included in the transformation region to be changed. On the other hand, as for the maintaining region of the feature region R0, the determiner 104 maintains the correlation between the respective pixel values of the plurality of pixels included in the maintaining region.

Specifically, as for the transformation region, the determiner 104 sets the straight line C1 and the distance D0 in the same way as in the first embodiment and sets D0×E2/E1 as the magnitude of shift with respect to each pixel. Note that the straight line C1 is a straight line parallel to the line Th1 indicating the threshold value.

As for the maintaining region, on the other hand, the determiner 104 determines the magnitude of shift to maintain the correlation (i.e., difference) between the pixel values (Z coordinate values) of adjacent pixels.

This processing will be described more specifically with reference to FIGS. 12-14 and FIG. 21. First, as for each of the plurality of pixels included in the feature region R0 (including both the transformation region and the maintaining region), the determiner 104 sets D0×E2/E1 as the magnitude of shift as in the first embodiment (refer to FIGS. 12 and 13). The superimposer 105 determines, based on the magnitude of shift determined by the determiner 104, a new pixel value with respect to each of a plurality of pixels included in the feature region R0 (refer to FIG. 14C).

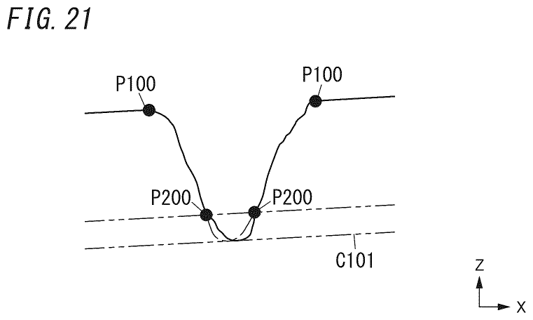

Finally, as for the plurality of pixels included in the maintaining region (i.e., pixels, of which the pixel values are less than the threshold value), the superimposer 105 replaces their pixel values (Z coordinate values) using the pixel value at the constituent point P200 at the boundary of the maintaining region as a reference value to maintain the correlation (difference) between the pixel values of adjacent pixels. For example, in the example shown in FIG. 21, the pixel value between the two constituent points P200 is changed from a value indicated by the two-dot chains into a value indicated by the solid line by replacing the pixel values to maintain the correlation between the pixel values of adjacent pixels.

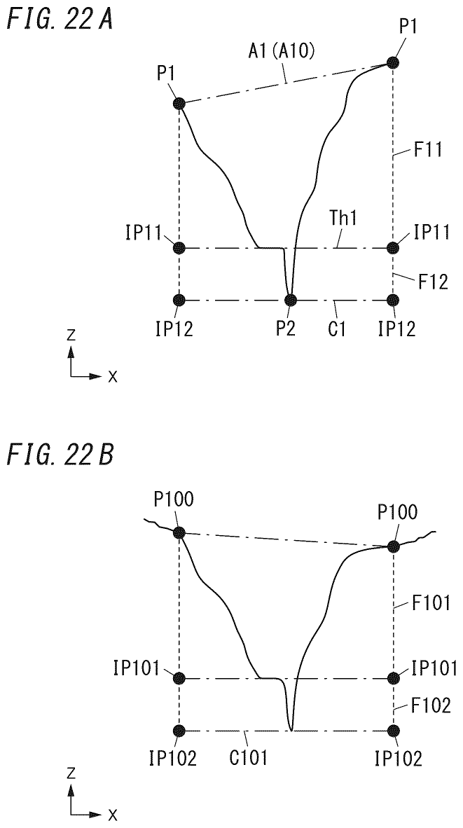

Viewing it from a different perspective, the determiner 104 transforms, by projective transformation, an image inside the quadrangular frame F11 shown in FIG. 22A into the image inside the quadrangular frame F101 shown in FIG. 22B. On the other hand, the determiner 104 moves as it is (i.e., translates) the image inside the quadrangular frame F12 shown in FIG. 22A into the quadrangular frame F102 shown in FIG. 22B. In this manner, the determiner 104 transforms the respective pixel values of a plurality of pixels corresponding to the line segment A1 into the magnitude of shift.

The quadrangular frame F11 is defined by the two constituent points P1 and two virtual points IP11 located at the intersections between the two straight lines extended in the Z-axis direction from the two constituent points P1 and the line Th1 indicating the threshold value. The quadrangular frame F12 is defined by the two virtual points IP11 and two virtual points IP12 located at the intersections between the two straight lines extended in the Z-axis direction from the two virtual points IP11 and the straight line C1.

The quadrangular frame F102 is defined by two virtual points IP102 located at the intersections between the two straight lines extended in the Z-axis direction from the two constituent points P100 and the virtual line C101 and two virtual points IP101 determined by shifting the Z coordinate value of the virtual points IP102 by the distance between the virtual points IP11 and IP12 of the quadrangular frame F12. The quadrangular frame F101 is defined by the two constituent points P100 and the two virtual points IP101.

In short, the determiner 104 determines the magnitude of shift using projective transformation.

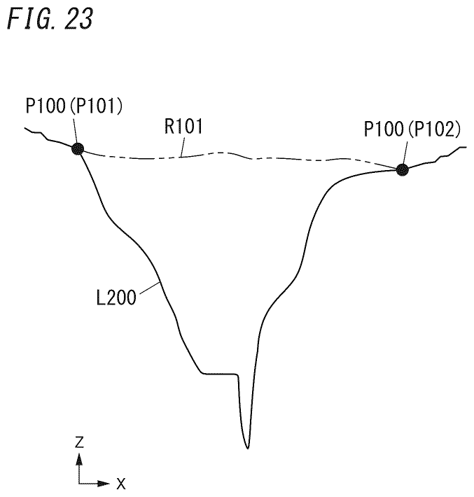

FIG. 23 shows the shape of a line L200 obtained by the processor 10 according to this embodiment and passing through the surface of the object after the superimposition in a pixel portion corresponding to the line segment R101 shown in FIG. 15.

According to this embodiment, before and after the determiner 104 (transformer) performs the transformation, the correlation between the respective pixel values of a plurality of pixels included in the maintaining region is maintained. This enables reducing the chances of performing transformation that makes the bottom surface of the pit B3 inclined with respect to the horizontal plane, for example. Thus, the data creation system 1 according to this embodiment enables generating learning data representing an image that is closer to an image that can exist in the real world. Consequently, this enables contributing to reducing the chances of causing a decline in the performance of recognizing the learned model M1 generated using learning data.

### (3) Variations

Note that the embodiments described above is only exemplary ones of various embodiments of the present disclosure and should not be construed as limiting. Rather, the exemplary embodiments may be readily modified in various manners depending on a design choice or any other factor without departing from the scope of the present disclosure. Also, the functions of the data creation system 1 according to the exemplary embodiments described above may also be implemented as a data creation method, a computer program, or a non-transitory storage medium on which the computer program is stored.

Next, variations of the exemplary embodiment will be enumerated one after another. Note that the variations to be described below may be adopted in combination as appropriate.

The data creation system 1 according to the present disclosure includes a computer system. The computer system may include a processor and a memory as principal hardware components thereof. The functions of the data creation system 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, in the embodiment described above, the plurality of functions of the data creation system 1 are aggregated together in a single housing. However, this is not an essential configuration for the data creation system 1. Alternatively, those constituent elements of the data creation system 1 may be distributed in multiple different housings.

Conversely, the plurality of functions of the data creation system 1 may be aggregated together in a single housing. Still alternatively, at least some functions of the data creation system 1 (e.g., some functions of the data creation system 1) may be implemented as, for example, a cloud computing system as well.

(3.1) First Variation

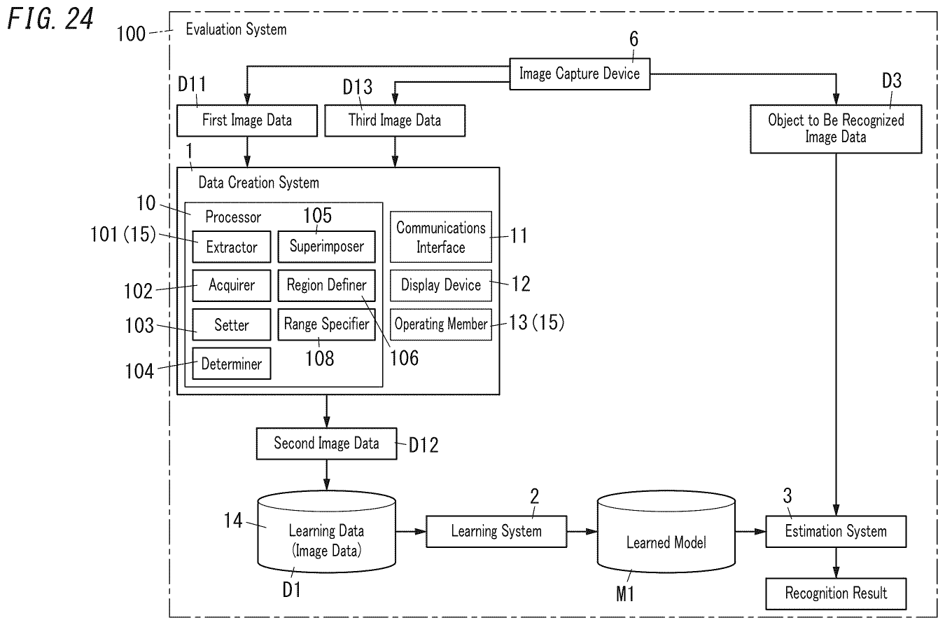

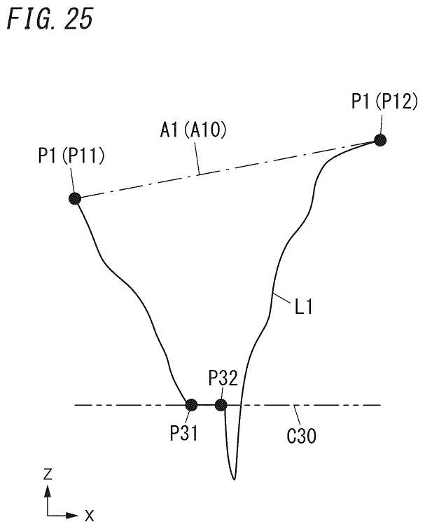

A data creation system 1 according to a first variation will be described with reference to FIGS. 24 and 25. In the data creation system 1 according to this variation, the maintaining region definer 106 defines the maintaining region based on a specified pixel, which is a difference from the data creation system 1 according to the second embodiment. In the following description, any constituent element of this first variation, having substantially the same function as a counterpart of the data creation system 1 according to the second embodiment described above, will be designated by the same reference numeral as that counterpart's, and description thereof will be omitted herein as appropriate.

As shown in FIG. 24, the processor 10 according to this variation includes a range specifier 108 instead of the threshold value specifier 107.

The range specifier 108 specifies a range covering at least one pixel (hereinafter referred to as a “particular pixel”) out of a plurality of pixels included in the feature region R0. The maintaining region definer 106 defines a maintaining region that covers the at least one pixel (particular pixel) specified by the range specifier 108.

In this case, the range specifier 108 specifies the particular pixel in accordance with the user's command. The user may specify the particular pixel using the operating member 13 while looking at the image displayed on the display device 12, for example.

For example, with a cross section (refer to FIG. 25) of the feature region R0 displayed on the display device 12, the user specifies, as the particular pixel, a pixel corresponding to an arbitrary constituent point which forms part of the surface of the feature region R0. For instance, in the example shown in FIG. 25, two pixels corresponding to constituent points P31, P32 are specified as particular pixels. The range specifier 108 sets a virtual section including a straight line C30 passing through these two constituent points P31, P32. The maintaining region definer 106 defines a maintaining region including pixels, of which the pixel values (Z coordinate values) are less than the virtual section.

In one example, the virtual section including the straight line C30 may be a virtual section including the straight line C30 and another straight line defined by translating the straight line C30 in the Y-axis direction. In another example, the virtual section including the straight line C30 may also be a virtual section including the two constituent points P31 and P32 and another constituent point specified separately from the constituent points P31 and P32 (i.e., three constituent points in total). Note that the three constituent points that define the virtual section do not have to include both of the two constituent points P31 and P32. Alternatively, the three constituent points may be respectively specified on three different cross sections.

As can be seen, the processor 10 according to this variation defines a maintaining region including the particular pixel specified by the range specifier 108. In addition, the determiner 104 transforms the respective pixel values of the plurality of pixels included in the feature region R0 into the magnitude of shift to maintain the correlation between the respective pixel values of the plurality of pixels included in the maintaining region. This enables reducing the chances of performing transformation that makes the bottom surface of the pit B3 inclined with respect to the horizontal plane, for example, as in the second embodiment described above. Thus, the data creation system 1 according to this variation enables creating learning data representing an image that is closer to an image that can exist in the real world.

In one variation, the maintaining region definer 106 may define the maintaining region based on only one particular pixel specified by the user. For example, the maintaining region definer 106 may set the pixel value (Z coordinate value) of one particular pixel specified by the user as a threshold value. Then, the maintaining region definer 106 may define the maintaining region based on a result of comparison between the threshold value and the respective pixel values (Z coordinate values) of the plurality of pixels included in the feature region R0 (i.e., based on their respective magnitudes).

In another variation, the processor 10 may include both the threshold value specifier 107 and the range specifier 108. In that case, the maintaining region definer 106 may define the maintaining region based on only the threshold value specified by the threshold value specifier 107. Alternatively, the maintaining region definer 106 may define the maintaining region based on only the particular pixel specified by the range specifier 108. Still alternatively, the maintaining region definer 106 may define the maintaining region based on both the threshold value and the particular pixel (e.g., based on an AND (logical product) or an OR (logical sum) of these two results).

(3.2) Second Variation

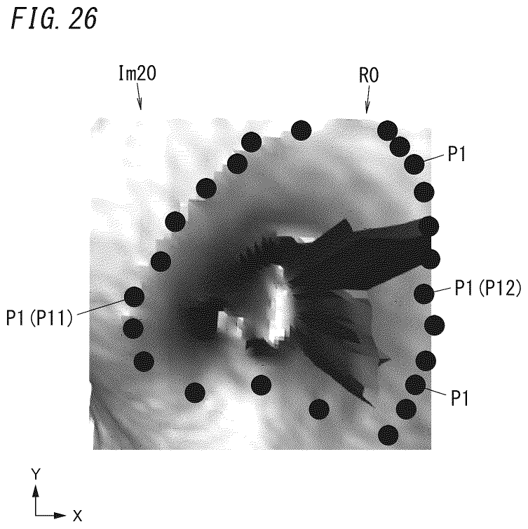

A data creation system 1 according to a second variation will be described with reference to FIG. 26. In the data creation system 1 according to this variation, the setter 103 sets a virtual plane based on the coordinate values of constituent points P1 with respect to two or more pixels that form the outer periphery of the feature region R0 and the determiner 104 performs transformation based on the virtual plane, which is a difference from the data creation system 1 according to the first embodiment described above. In the following description, any constituent element of this second variation, having substantially the same function as a counterpart of data creation system 1 according to the first embodiment described above, will be designated by the same reference numeral as that counterpart's, and description thereof will be omitted herein as appropriate.

In this variation, the setter 103 sets a virtual plane as either a virtual section or a virtual line. The virtual plane is set such that the average of the distances between the virtual plane and the coordinate values of constituent points P1 with respect to two or more pixels that form the outer periphery of the feature region R0 becomes minimum.

For example, as shown in FIG. 26, the setter 103 selects a plurality of pixels that form the outer periphery of the feature region R0, thus selecting a plurality of corresponding constituent points P1. When the plurality of constituent points P1 are selected, the setter 103 determines, based on the respective coordinate values (X, Y, and Z coordinates) of these constituent points P1, a virtual plane that makes the average of the distances (i.e., distances in the Z-axis direction) between the virtual plane and these constituent points P1 minimum.

The determiner 104 determines the magnitude of shift based on the virtual plane that has been set by the setter 103. The determiner 104 may determine the magnitude of shift by, for example, three-dimensional projective transformation. In that case, the superimposer 105 sets a virtual plane for the predetermined region R10 as in the case of the feature region R0 and may superimpose the magnitude of shift determined by the determiner 104 on the respective pixel values of the plurality of pixels included in the virtual plane.

The data creation system 1 according to this variation allows the determiner 104 to transform, based on a virtual plane as either a virtual section or a virtual line, the respective pixel values of a plurality of pixels in the feature region R0 into the magnitude of shift. This enables creating pseudo data closer to image data that can exist in the real world.

The configuration of the setter 103 according to this variation is applicable to the processor 10 according to the second embodiment.

(3.3) Third Variation

In the data creation system 1, the processing device (hereinafter referred to as a “first processing device”) 110 including the extractor 101 and the processing device (hereinafter referred to as a “second processing device”) 120 including the acquirer 102 and the superimposer 105 may be two different devices.

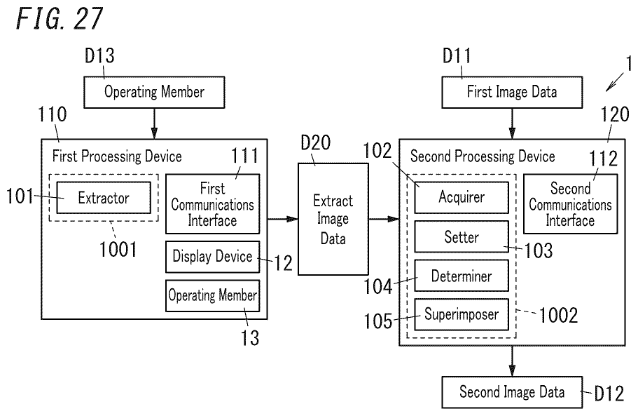

For example, as shown in FIG. 27, the first processing device 110 includes a processor (hereinafter referred to as a “first processor”) 1001, a communications interface (hereinafter referred to as a “first communications interface”) 111, the display device 12, and the operating member 13. The first processor 1001 of the first processing device 110 includes the extractor 101. The first processing device 110 includes a specifier 15 (including the operating member 13 and the extractor 101).

The first communications interface 111 receives, from the image capture device 6, the third image data D13 as original learning data representing an image (including a defect) of the object to be recognized.

The extractor 101 (specifier 15) extracts, from the third image data D13, extract image data including respective pixel values of a plurality of pixels included in the predetermined extraction region R1.

The first communications interface 111 (transmitter) outputs (transmits) the extract image data D20, extracted by the extractor 101, to the second processing device 120.

The second processing device 120 includes a processor (hereinafter referred to as a “second processor”) 1002 and a communications interface (hereinafter referred to as a “second communications interface”) 112. The second processor 1002 of the second processing device 120 includes the acquirer 102, the setter 103, the determiner 104, and the superimposer 105.

The second communications interface 112 receives, from the image capture device 6, the first image data D11 as original learning data. In addition, the second communications interface 112 also receives the extract image data D20 from the first processing device 110.

The acquirer 102 acquires, as feature image data indicating the pixel values of a plurality of pixels included in the feature region R0, the extract image data D20 received by the second communications interface 112. The setter 103 sets either a virtual section or a virtual line based on the pixel values of two or more pixels that form the outer periphery (contour) of the feature region R0. The determiner 104 determines the magnitude of shift based on either the virtual section or the virtual line. The superimposer 105 superimposes the magnitude of shift determined by the determiner 104 on the respective pixel values of a plurality of pixels included in the predetermined region R10 of the first image Im11 represented by the first image data D11, thereby creating the second image data D12.

The second processing device 120 may make, for example, the second communications interface 112 transmit the second image data D12 thus created to the first processing device 110. In that case, the user may make the learning system 2 generate the learned model M1 using the second image data D12 thus received.

The second processing device 120 may transmit the second image data D12 thus generated to an external server including a learning system. The learning system of the external server generates a learned model M1 using a learning data set including learning data as the second image data D12. This learned model M1 outputs, in response to either the second image Im12 represented by the second image data D12 or the predetermined region R10 in the second image Im12 a result of estimation similar to a situation where the third image data D13 is the object to be recognized. In this case, the predetermined region R10 is a region included in the first image Im11 and having an outer peripheral shape corresponding to the extraction region R1. The first image Im11 includes a pixel region indicating the object to be recognized and is represented by the first image data D11. The second image Im12 is generated by superimposing the magnitude of shift that has been determined based on the respective pixel values of a plurality of pixels included in the extraction region R1 on the respective pixel values of a plurality of pixels included in the predetermined region R10. An exemplary result of estimation may indicate whether the object to be recognized is a good product or a defective product. The exemplary result of estimation may include the type of the defect if the object to be recognized is a defective product. The exemplary result of estimation may include the size of the defect if the object to be recognized is a defective product. If the object to be recognized is a defective product and the type of the defect is the pit B3, the exemplary result of estimation may include the depth of the pit B3. The user may receive the learned model M1 thus generated from the external server.

(3.4) Other Variations

In one variation, the object to be recognized does not have to be the weld bead B10. That is to say, the learned model M1 does not have to be used in the weld appearance test to check whether welding has been performed properly.

In another variation, the feature image data does not have to be extract image data extracted from the third image data D13 for use as the learning data. Alternatively, the feature image data may also be data created arbitrarily by the user, for example. Also, the feature image data acquired by the acquirer 102 does not have to be the extract image data extracted by the extractor 101. Alternatively, the acquirer 102 may acquire the feature image data from another device by communication, for example. Still alternatively, the acquirer 102 may acquire the feature image data stored in advance in a storage device of the processor 10 from the storage device.

In still another variation, the feature image data does not have to be data of an image of a defective product but may also be data of an image of a good product.

In yet another variation, the first image data D11 may be data representing an image showing a defect of the object to be recognized. In yet another variation, the first image data D11 may be the same as the third image data D13.

In yet another variation, the processor 10 may perform the processing of defining the extraction region R1, defining the predetermined region R10, and defining the maintaining region according to an appropriately set reference, instead of following the user's command.

In yet another variation, the plurality of line segments A1 do not have to be line segments aligned with the X-axis but may also be line segments aligned with the Y-axis, for example. Nevertheless, the plurality of line segments A1 are preferably parallel to each other when viewed along the Z-axis (i.e., when viewed from in front of the paper on which FIG. 10 is drawn).

In yet another variation, the image represented by the feature image data may also be deformed (e.g., rotated, flipped, or scaled up or down).

In yet another variation, the first image data D11 and the third image data D13 do not have to be distance image data but may also be luminance image data.

The “image data” as used herein does not have to be image data acquired by an image sensor but may also be two-dimensional data such as a CG image or two-dimensional data formed by arranging multiple items of one-dimensional data acquired by a distance image sensor as already described for the basic example. Alternatively, the “image data” may also be three- or higher-dimensional data. Furthermore, the “pixels” as used herein do not have to be pixels of an image actually captured with an image sensor but may also be respective elements of two-dimensional data.

The evaluation system 100 may include only some of the constituent elements of the data creation system 1. For example, the evaluation system 100 may include only the first processing device 110, out of the first processing device 110 and the second processing device 120 (refer to FIG. 13) of the data creation system 1, and the learning system 2. The functions of the first processing device 110 and the functions of the learning system 2 may be provided for a single device. Alternatively, the evaluation system 100 may include, for example, only the first processing device 110, out of the first processing device 110 and the second processing device 120 of the data creation system 1, and the estimation system 3. The functions of the first processing device 110 and the functions of the estimation system 3 may be provided for a single device.

### (4) Aspects

As can be seen from the foregoing description, the embodiments and their variations described above may be specific implementations of the following aspects of the present disclosure.

A data creation system (1) according to a first aspect creates, based on first image data (D11), second image data (D12) for use as learning data to generate a learned model (M1). The data creation system (1) includes an acquirer (102) and a superimposer (105). The acquirer (102) acquires feature image data indicating respective pixel values of a plurality of pixels included in a feature region (R0). The superimposer (105) creates the second image data (D12) by superimposing a magnitude of shift on respective pixel values of a plurality of pixels included in a predetermined region (R10) of a first image (Im11) represented by the first image data (D11). The predetermined region (R10) has an outer peripheral shape corresponding to the feature region (R0). The magnitude of shift is determined based on the respective pixel values of the plurality of pixels included in the feature region (R0).

This aspect enables generating learning data representing an image closer to an image that can exist in the real world, thus contributing to reducing the chances of causing a decline in the performance of recognizing the learned model (M1) generated based on the learning data.

In a data creation system (1) according to a second aspect, which may be implemented in conjunction with the first aspect, the first image data (D11) is distance image data including pixel values expressed as distance values.

This aspect enables generating learning data representing an image closer to an image that can exist in the real world.

A data creation system (1) according to a third aspect, which may be implemented in conjunction with the second aspect, further includes a determiner (104) and a setter (103). The determiner (104) determines the magnitude of shift based on the respective pixel values of the plurality of pixels in the feature region (R0). The setter (103) sets either a virtual section or a virtual line based on respective pixel values of two or more pixels that form an outer periphery of the feature region (R0). The determiner (104) determines the magnitude of shift by transformation based on either the virtual section or the virtual line.

This aspect enables generating learning data representing an image closer to an image that can exist in the real world.

In a data creation system (1) according to a fourth aspect, which may be implemented in conjunction with the third aspect, the setter (103) sets, with respect to each of the two or more pixels that form the outer periphery of the feature region (R0), a constituent point (P1) using coordinates and a pixel value of each pixel as coordinate values of a three-dimensional coordinate system. The setter (103) sets, using the coordinate values of the constituent point (P1) with respect to each of the two or more pixels, either the virtual section or the virtual line within the three-dimensional coordinate system.

This aspect enables generating learning data representing an image closer to an image that can exist in the real world.

In a data creation system (1) according to a fifth aspect, which may be implemented in conjunction with the fourth aspect, the virtual section or the virtual line includes a virtual plane. The setter (103) sets the virtual plane to minimize an average distance between the coordinate values of the constituent points (P1) and the virtual plane with respect to the two or more pixels.

This aspect enables generating learning data representing an image closer to an image that can exist in the real world.

In a data creation system (1) according to a sixth aspect, which may be implemented in conjunction with the fourth aspect, either the virtual section or the virtual line includes a plurality of virtual lines. The setter (103) sets, as each of the plurality of virtual lines, a line segment (A1, A10) that connects two constituent points (P11, P12) arranged side by side in one direction and selected from the constituent points (P1) with respect to the two or more pixels.

This aspect enables generating learning data representing an image closer to an image that can exist in the real world.

A data creation system (1) according to a seventh aspect, which may be implemented in conjunction with any one of the first to sixth aspects, further includes a determiner (104). The determiner (104) determines the magnitude of shift based on the respective pixel values of the plurality of pixels in the feature region (R0). The determiner (104) determines the magnitude of shift using projective transformation.

This aspect enables generating learning data representing an image closer to an image that can exist in the real world.

A data creation system (1) according to an eighth aspect, which may be implemented in conjunction with any one of the first to seventh aspects, further includes a determiner (104) and a maintaining region definer (106). The determiner (104) determines the magnitude of shift based on the respective pixel values of the plurality of pixels in the feature region (R0). The maintaining region definer (106) defines, in the feature region (R0), a maintaining region where a correlation between respective pixel values of adjacent pixels is maintained. The determiner (104) determines the magnitude of shift by transformation to maintain the correlation between the respective pixel values of the plurality of pixels included in the maintaining region.

This aspect enables generating learning data representing an image closer to an image that can exist in the real world.

A data creation system (1) according to a ninth aspect, which may be implemented in conjunction with the eighth aspect, further includes a threshold value specifier (107) that specifies a threshold value. The maintaining region definer (106) defines the maintaining region based on a result of comparison between the threshold value and the respective pixel values of the plurality of pixels included in the feature region (R0).

This aspect enables generating learning data representing an image closer to an image that can exist in the real world.

A data creation system (1) according to a tenth aspect, which may be implemented in conjunction with the eighth or ninth aspect, further includes a range specifier (108). The range specifier (108) specifies a range covering at least one pixel out of the plurality of pixels included in the feature region (R0). The maintaining region definer (106) defines the maintaining region to make the maintaining region cover the at least one pixel specified by the range specifier (108).

This aspect enables generating learning data representing an image closer to an image that can exist in the real world.

A data creation system (1) according to an eleventh aspect, which may be implemented in conjunction with any one of the first to tenth aspects, further includes an extractor (101). The extractor (101) extracts, from third image data (D13) for use as the learning data, extract image data including respective pixel values of a plurality of pixels included in a predetermined extraction region (R1). The acquirer (102) acquires the extract image data as the feature image data.

This aspect enables generating learning data representing an image closer to an image that can exist in the real world.

A learning system according to a twelfth aspect generates the learned model (M1) using a learning data set including the learning data as the second image data (D12) created by the data creation system (1) according to any one of the first to eleventh aspects.

This aspect contributes to reducing the chances of causing a decline in the performance of recognizing the learned model (M1).

An estimation system according to a thirteenth aspect makes estimation about an object to be recognized using the learned model (M1) generated by the learning system according to the twelfth aspect.

According to this aspect, estimation is made about the object to be recognized using a learned model while reducing the chances of causing a decline in the recognition performance, thus enabling obtaining appropriate estimation results.

A data creation method according to a fourteenth aspect is designed to create, based on first image data (D11), second image data (D12) for use as learning data to generate a learned model (M1). The data creation method includes an acquiring step and a superimposing step. The acquiring step includes acquiring feature image data indicating respective pixel values of a plurality of pixels included in a feature region (R0). The superimposing step includes creating the second image data (D12) by superimposing a magnitude of shift on respective pixel values of a plurality of pixels included in a predetermined region (R10) of a first image (Im11) represented by the first image data (D11). The predetermined region (R10) has an outer peripheral shape corresponding to the feature region (R0). The magnitude of shift is determined based on the respective pixel values of the plurality of pixels included in the feature region (R0).

This aspect enables generating learning data representing an image closer to an image that can exist in the real world, thus contributing to reducing the chances of causing a decline in the performance of recognizing the learned model (M1) generated based on the learning data.

A program according to a fifteenth aspect is designed to cause one or more processors to perform the data creation method according to the fourteenth aspect.

This aspect enables generating learning data representing an image closer to an image that can exist in the real world, thus contributing to reducing the chances of causing a decline in the performance of recognizing the learned model (M1) generated based on the learning data.

A data creation system (1) according to a sixteenth aspect, which may be implemented in conjunction with the eleventh aspect, includes a first processing device (110) and a second processing device (120). The first processing device (110) includes the extractor (101). The second processing device (120) includes the acquirer (102) and the superimposer (105). The first processing device (110) transmits the extract image data (D20) to the second processing device (120). The second processing device (120) receives the extract image data (D20) from the first processing device (110). The acquirer (102) of the second processing device (120) acquires the extract image data (D20) as the feature image data.

This aspect contributes to reducing the chances of causing a decline in the performance of recognizing the learned model (M1).

In a data creation system (1) according to a seventeenth aspect, which may be implemented in conjunction with the sixteenth aspect, the first processing device (110) further includes a specifier (15). The specifier (15) specifies, in accordance with an operating command entered by a user, the predetermined extraction region (R1) based on the third image data (D13).

A processing device according to an eighteenth aspect functions as the first processing device (110) of the data creation system (1) according to the sixteenth or seventeenth aspect.

A processing device according to a nineteenth aspect functions as the second processing device (120) of the data creation system (1) according to the sixteenth or seventeenth aspect.

An evaluation system (100) according to a twentieth aspect includes a pressing device (110) and a learning system (2). The processing device (110) extracts, from third image data (D13) representing a third image (Im13) including a pixel region indicating an object to be recognized, extract image data including respective pixel values of a plurality of pixels included in a predetermined extraction region (R1). The processing device (110) outputs the extract image data (D20) thus extracted. The learning system (2) generates a learned model (M1). The learned model (M1) outputs, in response to either a second image (Im12) represented by second image data (D12) or a predetermined region (R10) in the second image (Im12), an estimation result similar to a situation where the third image data (D13) is the object to be recognized. The predetermined region (R10) is a region included in the first image (Im11) and having an outer peripheral shape corresponding to the extraction region (R1). The first image (Im11) includes a pixel region indicating the object to be recognized and is represented by first image data (D11). The second image (Im12) is generated by superimposing a magnitude of shift on respective pixel values of a plurality of pixels included in the predetermined region (R10) of the first image (Im11). The magnitude of shift is determined based on the respective pixel values of the plurality of pixels included in the extraction region (R1).

This aspect contributes to reducing the chances of causing a decline in the performance of recognizing the learned model (M1).

A processing device (110) according to a twenty-first aspect functions as the processing device (110) of the evaluation system (100) according to the twentieth aspect.

A learning system (2) according to a twenty-second aspect functions as the learning system (2) of the evaluation system (100) according to the twentieth aspect.

An evaluation system (100) according to a twenty-third aspect includes a processing device (110) and an estimation system (3). The processing device (110) extracts, from third image data (D13) representing a third image (Im13) including a pixel region indicating an object to be recognized, extract image data including respective pixel values of a plurality of pixels included in a predetermined extraction region (R1). The processing device (110) outputs the extract image data (D20) thus extracted. The estimation system (3) makes estimation about the object to be recognized using a learned model (M1). The learned model (M1) outputs, in response to either a second image (Im12) represented by second image data (D12) or a predetermined region (R10) in the second image (Im2), an estimation result similar to a situation where the third image data (D13) is the object to be recognized. The predetermined region (R10) is a region included in the first image (Im1i) and having an outer peripheral shape corresponding to the extraction region (R1). The first image (Im11) includes a pixel region indicating the object to be recognized and is represented by first image data (D11). The second image (Im12) is generated by superimposing a magnitude of shift on respective pixel values of a plurality of pixels included in the predetermined region (R10) of the first image (Im11). The magnitude of shift is determined based on the respective pixel values of the plurality of pixels included in the extraction region (R1).

This aspect contributes to reducing the chances of causing a decline in the performance of recognizing the learned model (M1).

A processing device (110) according to a twenty-fourth aspect functions as the processing device (110) of the evaluation system (100) according to the twenty-third aspect.

A learning system (2) according to a twenty-fifth aspect functions as the estimation system (3) of the evaluation system (100) according to the twenty-third aspect.

Note that the constituent elements according to the second to eleventh aspects and the sixteenth and seventeenth aspects are not essential constituent elements for the data creation system (1) but may be omitted as appropriate.

### REFERENCE SIGNS LIST

1 Data Creation System
101 Extractor
102 Acquirer
103 Setter
104 Determiner
105 Superimposer
106 Maintaining Region Definer
107 Threshold Value Specifier
108 Range Specifier
15 Specifier
100 Evaluation System
110 First Processing Device (Processing Device)
120 Second Processing Device
2 Learning System
3 Estimation System
D11 First Image Data
D12 Second Image Data
D13 Third Image Data
D20 Extracted Image Data
Im11 First Image
Im12 Second Image
Im13 Third Image
R0 Feature Region
R1 Extraction Region
R10 Predetermined Region
P1, P11, P12 Constituent Point
A1, A10 Line Segment
M1 Learned Model

1. A data creation system configured to create, based on first image data, second image data for use as learning data to generate a learned model, the data creation system comprising:
an acquirer configured to acquire feature image data indicating respective pixel values of a plurality of pixels included in a feature region; and
a superimposer configured to create the second image data by superimposing a magnitude of shift on respective pixel values of a plurality of pixels included in a predetermined region of a first image represented by the first image data, the predetermined region having an outer peripheral shape corresponding to the feature region, the magnitude of shift being determined based on the respective pixel values of the plurality of pixels included in the feature region.

2. The data creation system of claim 1, wherein
the first image data is distance image data including pixel values expressed as distance values.

3. The data creation system of claim 2, further comprising:
a determiner configured to determine the magnitude of shift based on the respective pixel values of the plurality of pixels in the feature region; and
a setter configured to set either a virtual section or a virtual line based on respective pixel values of two or more pixels that form an outer periphery of the feature region, wherein
the determiner is configured to determine the magnitude of shift based on either the virtual section or the virtual line.

4. The data creation system of claim 3, wherein
the setter is configured to set, with respect to each of the two or more pixels, a constituent point using coordinates and a pixel value of each said pixel as coordinate values of a three-dimensional coordinate system, and
the setter is configured to set, using the coordinate values of the constituent point with respect to each of the two or more pixels, either the virtual section or the virtual line within the three-dimensional coordinate system.

5. The data creation system of claim 4, wherein
the virtual section or the virtual line includes a virtual plane, and
the setter is configured to set the virtual plane to minimize an average distance between the coordinate values of the constituent points and the virtual plane with respect to the two or more pixels.

6. The data creation system of claim 4, wherein
either the virtual section or the virtual line includes a plurality of virtual lines, and
the setter is configured to set, as each of the plurality of virtual lines, a line segment that connects two constituent points arranged side by side in one direction and selected from the constituent points with respect to the two or more pixels.

7. The data creation system of claim 1, further comprising a determiner configured to determine the magnitude of shift based on the respective pixel values of the plurality of pixels in the feature region, wherein
the determiner is configured to determine the magnitude of shift using projective transformation.

8. The data creation system of claim 1, further comprising:
a determiner configured to determine the magnitude of shift based on the respective pixel values of the plurality of pixels in the feature region; and
a maintaining region definer configured to define a maintaining region in the feature region, a correlation between respective pixel values of adjacent pixels being maintained in the maintaining region, wherein
the determiner is configured to determine the magnitude of shift to maintain a correlation between the respective pixel values of the plurality of pixels included in the maintaining region.

9. The data creation system of claim 8, further comprising a threshold value specifier configured to specify a threshold value, wherein
the maintaining region definer is configured to define the maintaining region based on a result of comparison between the threshold value and the respective pixel values of the plurality of pixels included in the feature region.

10. The data creation system of claim 8, further comprising a range specifier configured to specify a range covering at least one pixel out of the plurality of pixels included in the feature region, wherein
the maintaining region definer is configured to define the maintaining region to make the maintaining region cover the at least one pixel specified by the range specifier.

11. The data creation system of claim 1, further comprising an extractor configured to extract, from third image data for use as the learning data, extract image data including respective pixel values of a plurality of pixels included in a predetermined extraction region, wherein
the acquirer is configured to acquire the extract image data as the feature image data.

12. A learning system configured to generate the learned model using a learning data set, the learning data set including the learning data as the second image data, the second image data being created by the data creation system of claim 1.

13. An estimation system configured to make estimation about an object to be recognized using the learned model generated by the learning system of claim 12.

14. A data creation method for creating, based on first image data, second image data for use as learning data to generate a learned model, the data creation method comprising:
an acquiring step including acquiring feature image data indicating respective pixel values of a plurality of pixels included in a feature region; and
a superimposing step including creating the second image data by superimposing a magnitude of shift on respective pixel values of a plurality of pixels included in a predetermined region of a first image represented by the first image data, the predetermined region having an outer peripheral shape corresponding to the feature region, the magnitude of shift being determined based on the respective pixel values of the plurality of pixels included in the feature region.

15. A non-transitory storage medium storing a program designed to cause one or more processors to perform the data creation method of claim 14.

16. The data creation system of claim 11, comprising a first processing device and a second processing device, wherein
the first processing device includes the extractor,
the second processing device includes the acquirer and the superimposer,
the first processing device is configured to transmit the extract image data to the second processing device,
the second processing device is configured to receive the extract image data from the first processing device, and
the acquirer of the second processing device is configured to acquire the extract image data as the feature image data.

17. The data creation system of claim 16, wherein
the first processing device further includes a specifier configured to specify, in accordance with an operating command entered by a user, the predetermined extraction region based on the third image data.

18. A processing device functioning as the first processing device of the data creation system of claim 16.

19. A processing device functioning as the second processing device of the data creation system of claim 16.

20. An evaluation system comprising a processing device and a learning system,
the processing device being configured to extract, from third image data representing a third image including a pixel region indicating an object to be recognized, extract image data including respective pixel values of a plurality of pixels included in a predetermined extraction region, and output the extract image data thus extracted,
the learning system being configured to generate a learned model, the learned model being configured to output, in response to either a second image represented by second image data or a predetermined region in the second image, an estimation result similar to a situation where the third image data is the object to be recognized, the second image data being generated by superimposing a magnitude of shift on respective pixel values of a plurality of pixels included in the predetermined region in a first image including a pixel region indicating the object to be recognized and represented by first image data, the predetermined region having an outer peripheral shape corresponding to the extraction region, the magnitude of shift being determined based on the respective pixel values of the plurality of pixels included in the extraction region.

21. A processing device functioning as the processing device of the evaluation system of claim 20.

22. A learning system functioning as the learning system of the evaluation system of claim 20.

23. An evaluation system comprising a processing device and an estimation system,
the processing device being configured to extract, from third image data representing a third image including a pixel region indicating an object to be recognized, extract image data including respective pixel values of a plurality of pixels included in a predetermined extraction region, and output the extract image data thus extracted,
the estimation system being configured to make estimation about the object to be recognized using a learned model,
the learned model being configured to output, in response to either a second image represented by second image data or a predetermined region in the second image, an estimation result similar to that for a situation where the third image data is the object to be recognized, the second image data being created by superimposing a magnitude of shift on respective pixel values of a plurality of pixels included in the predetermined region in a first image including a pixel region indicating the object to be recognized and represented by first image data, the predetermined region having an outer peripheral shape corresponding to the extraction region, the magnitude of shift being determined based on the respective pixel values of the plurality of pixels included in the extraction region.

24. A processing device functioning as the processing device of the evaluation system of claim 23.

25. An estimation system functioning as the estimation system of the evaluation system of claim 23.
